(19) United States
(12) Patent Application Publication
(10) Pub. No.: US 2025/0356226 A1
(43) Pub. Date: Nov. 20, 2025

(54) SYSTEMS AND METHODS FOR PREDICTING PATHS FOR MULTI-PARTY SITUATIONS

(71) Applicant: Acertas LLC, Claremont, CA (US)

(72) Inventors: Mark Abdollahian, Altadena, CA (US); Yadong Ruan, Upland, CA (US); Khaled Eid, Claremont, CA (US); Qiao Yang, Upland, CA (US); Jacek Kugler, Claremont, CA (US); Qiyun Li, Montclair, CA (US); Domrongphol Sangmanee, Bangkok (TH); Linfeng Li, Pomona, CA (US); Feifan Chen, Montclair, CA (US); Zhamilia Klycheva, Claremont, CA (US); Sippanon Kitimoon, Pomona, CA (US); Theeraphat Pothisawang, Pomona, CA (US)

(21) Appl. No.: 18/785,871

(22) Filed: Jul. 26, 2024

Related U.S. Application Data
(63) Continuation-in-part of application No. 18/084,156, filed on Dec. 19, 2022.
Application No. 18/084,156 is a continuation-in-part of application No. 17/867,126, filed on Jul. 18, 2022, now Pat. No. 11,531,921.
Application No. 17/867,126 is a continuation of application No. 17/229,297, filed on Apr. 13, 2021, now Pat. No. 11,392,847.
Application No. 18/084,156 is a continuation-in-part of application No. 16/425,699, filed on May 29, 2019, now abandoned.
(60) Provisional application No. 62/693,004, filed on Jul. 2, 2018.
(60) Provisional application No. 63/009,252, filed on Apr. 13, 2020.

(51) Int. Cl. G06N 7/01; G06N 20/00

(52) U.S. Cl. CPC G06N 7/01; G06N 20/00

(57) ABSTRACT

A decision-making analysis computer device for advanced horizon scanning and deep searching is provided. The computer device includes at least one processor in communication with at least one memory. The at least one processor programmed to: a) receive one or more inputs for a model associated with an issue; b) create a scenario generator; c) execute the scenario generator with the one or more inputs to generate a plurality of scenarios; d) execute a plurality of runs of the model with the plurality of scenarios as inputs to generate a plurality of outputs; and/or e) categorize the plurality of outputs of the model of the plurality of the plurality of runs of the model.

### CROSS REFERENCE TO RELATED APPLICATIONS

This application is a continuation-in-part of and claims priority to U.S. patent application Ser. No. 18/084,256, filed Dec. 19, 2022, which is a continuation-in-part of and claims priority to U.S. patent application Ser. No. 17/867,126, filed Jul. 18, 2022, and issued as U.S. Pat. No. 11,531,921, on Dec. 20, 2022, which claims priority to and is a continuation of U.S. patent application Ser. No. 17/229,297, filed Apr. 13, 2021, which issued as U.S. Pat. No. 11,392,847 on Jul. 19, 2022, and which claims priority to U.S. Provisional Application 63/009,252, filed Apr. 13, 2020, and is also a continuation-in-part of and claims priority to U.S. patent application Ser. No. 16/425,699, filed May 29, 2019, which claims priority to U.S. Provisional Application No. 62/693,004, entitled “SYSTEMS AND METHODS FOR PREDICTING PATHS FOR MULTI-PARTY SITUATIONS,” which was filed Jul. 2, 2018, the entire contents and disclosure of which are hereby incorporated herein by reference in their entirety.

### BACKGROUND

The field of the invention relates generally to predicting paths for multi-party situations and more particularly to methods and systems for determining optimal paths for multi-party situations through high-level simulation of negotiations, such as business negotiations, joint ventures, political policy, and legal actions.

In complex negotiations, a large number of actors may affect each other and the outcome of the negotiation. These negotiations may include, for example, business negotiations, joint ventures, political policy, and legal actions. Changes in the position of one or more of the actors may cascade and influence the other actors. Furthermore, actors may only be influenced in certain stages of the negotiation. In addition, some actors may have hidden agendas. Some actors may prevent successful negotiation based on how they are approached, when they were approached, and who was approached before or after them. Accordingly, is would be advisable to determine the best time and way to approach the different actors in a negotiation necessary for a successful negotiation. Furthermore, there is potentially deep uncertainty surrounding human behavior on any issue. This may lead to additional risks and/or otherwise unknown scenarios that can significantly change anticipated outcomes, known as horizon scanning.

### BRIEF DESCRIPTION

In one aspect, a decision-making analysis computer device for determining optimal paths for multi-party situations through high-level simulation is provided. The computer device includes at least one processor in communication with at least one memory. The at least one processor is programmed to determine a desired outcome for an issue based on a plurality of data. The at least one processor is also programmed to determine a plurality of stakeholders for the issue based on the plurality of data. The at least one processor is further programmed to generate a plurality of strategies for the issue based on the plurality of stakeholders and the plurality of data. Each strategy of the plurality of strategies includes a plurality of actions performed by one or more of the stakeholders of the plurality of stakeholders. In addition, the at least one processor is programmed to determine at least one strategy that achieves the desired outcome based on the plurality of strategies.

In another aspect, a system for determining optimal paths for multi-party situations through high-level simulation is provided. The system includes a computer device including at least one processor in communication with at least one memory. The at least one processor is programmed to determine a desired outcome for an issue based on a plurality of data. The at least one processor is also programmed to determine a plurality of stakeholders for the issue based on the plurality of data. The at least one processor is further programmed to determine a plurality of initial positions for the plurality of stakeholders based on the plurality of data. In addition, the at least one processor is programmed to execute a first round of analysis of the issue by applying a first plurality of actions to the plurality of initial positions of the plurality of stakeholders. Furthermore, the at least one processor is programmed to for each of the plurality of scenarios, determine one or more changes of position for one or more stakeholders of the plurality of stakeholders.

In a further aspect, a decision-making analysis computer device for determining optimal paths for multi-party, multiple negotiation issue situations through high-level simulation are provided. The computer device includes at least one processor in communication with at least one memory. The at least one processor is programmed to determine a plurality of desired outcomes for a plurality of issues based on a plurality of data. For each of the issues, at least one processor is also programmed to determine a plurality of stakeholders associated with that corresponding issue based on the plurality of data. For a first issue of the plurality of issues, the at least one processor is further programmed to analyze the first issue to determine a first plurality of strategies and tactics associated with the corresponding desired outcome. In addition, for a second issue of the plurality of issues, at least one processor is programmed to analyze the second issue to determine a second plurality of strategies and tactics associated with the corresponding desired outcome. Furthermore, at least one processor is programmed to compare the first plurality of strategies and tactics with the second plurality of strategies and tactics to determine one or more issue tradeoffs.

In an additional aspect, a decision-making analysis computer device for advanced horizon scanning and deep searching is provided. The computer device includes at least one processor in communication with at least one memory, the at least one processor programmed to: a) receive one or more inputs for a model associated with an issue; b) create a scenario generator; c) execute the scenario generator with the one or more inputs to generate a plurality of scenarios; d) execute a plurality of runs of the model with the plurality of scenarios as inputs to generate a plurality of outputs; and/or e) categorize the plurality of outputs of the model of the plurality of the plurality of runs of the model. The computer device may have instructions that direct additional, less, or alternate functionality, including that discussed elsewhere herein.

In still a further embodiment, a system for advanced horizon scanning and deep searching is provided. The system includes a computer device comprising at least one processor in communication with at least one memory. The at least one processor programmed to: a) receive one or more inputs for a model associated with an issue; b) create a scenario generator; c) execute the scenario generator with the one or more inputs to generate a plurality of scenarios; d) execute a plurality of runs of the model with the plurality of scenarios as inputs to generate a plurality of outputs; and/or e) categorize the plurality of outputs of the model of the plurality of the plurality of runs of the model. The system may have instructions that direct additional, less, or alternate functionality, including that discussed elsewhere herein.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each Figure is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a data flow diagram for a process for determining optimal paths for multi-party situations through high-level simulation in accordance with one embodiment of the disclosure.

FIG. 1 illustrates a data flow diagram for a process for determining optimal paths for multi-party situations through high-level simulation in accordance with one embodiment of the disclosure.

FIG. 2 illustrates a graphical view of the data flows of generating a plurality of tactics in accordance with the process shown in FIG. 1.

FIG. 3 illustrates a graphical view of a matrix showing the ranking of strategies based on criteria in accordance with the process shown in FIG. 1.

FIG. 4 illustrates a graphical view of a flowchart of analyzing alternative future scenarios generated using the process shown in FIG. 1.

FIG. 5 illustrates a flow chart of a process for determining and ranking leverages in accordance with one embodiment of the disclosure.

FIG. 6 illustrates a graphical flow chart of a process for analyzing multiple issues in accordance with the process shown in FIG. 1.

FIG. 7 illustrates a simplified block diagram of an exemplary decision-making analysis system for determining optimal paths for multi-party situations through high-level simulation based on the process shown in FIG. 1.

FIG. 8 illustrates an exemplary configuration of a client computer device as shown in FIG. 7, in accordance with one embodiment of the present disclosure.

FIG. 9 illustrates an exemplary configuration of a server system as shown in FIG. 7, in accordance with one embodiment of the present disclosure.

FIG. 10 illustrates a flow chart of a process for determining optimal paths for multi-party situations through high-level simulation as shown in FIGS. 1 to 4 using the decision-making analysis system shown in FIG. 7.

FIG. 11 illustrates a data flow diagram for a process for determining optimal paths for multi-party situations with multiple issues in accordance with one embodiment of the disclosure.

FIG. 12 illustrates a flowchart of process advanced horizon scanning and deep searching system, in accordance with at least one embodiment.

FIG. 13 illustrates a flowchart of process for deep searching for the advanced horizon scanning and deep searching system, in accordance with at least one embodiment.

FIG. 14 illustrates an exemplary boosting process for deep searching in accordance with at least one embodiment of the disclosure.

FIG. 15 illustrates an example of the key attribute extraction process for deep searching in accordance with at least one embodiment of the disclosure.

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein.

### DETAILED DESCRIPTION

The described embodiments enable the prediction of paths for multi-party situations. More particularly, the present disclosure is directed a decision-making analysis (DMA) computer system for determining optimal paths for multi-party situations through high-level simulation. For the purposes of this discussion, the multi-party situation is a negotiation. Ones having ordinary skill in the art may determine other multi-party situations where the methods and systems described herein would apply, such as, but not limited to, planning for legal action, diplomatic overtures, and joint venture planning.

For the purposes of this discussion, an issue continuum is a map between the range of descriptive negotiation issue outcome and real numbers, where the issue continuum allows the description of an issue outcome to be translated into real numbers. In the exemplary embodiments, these numbers are displayed in a continuum.

A position is a real number associated with a stakeholder's publically shown support of the issue outcome. A stakeholder is any entity that might be directly or indirectly involved in the negotiation. For quantitative analysis purposes, any stakeholder may be represented in the analysis as a set of properties that contain information, such as, but not limited to, name, group, position, influence, group influence, and importance. The group represents a group that the stakeholder is a part of, such as if the stakeholder is a member of company A. Influence represents the individual stakeholder's ability to influence other stakeholders, which may include how much power this stakeholder has relative to the other stakeholders. Position represents the stakeholder's position within the associated group. The group influence represents the ability of the group to influence other stakeholders, effectively how much power does company A have in relation to the other groups. Importance represents how important these negotiations and the outcome of the negotiations is to the stakeholder. This may also represent how many resources the stakeholder is willing to devote to this issue.

For the purposes of this discussion, initial data contains a set of stakeholders. The issue includes the initial data and the issue continuum as described herein. The basecase is the initial data of the issue, which is derived from the ‘real world’ situation. Effectively, the basecase represents the anticipated negotiation dynamics and outcomes from simulating multiple rounds of negotiation. A scenario is a change of the initial data that reflects changes from any “what-if” scenarios that were applied to the initial data. For example, what if the current CEO of company A resigned or was fired? Scenarios are analyzed to determine how this change will impact the outcome. In some embodiments, each issue includes one basecase and a plurality of scenarios.

A proposal is an interaction between a pair of stakeholders in a round of negotiations. There are four possible proposal types: leverage, pressure, move, and offer. A leverage represents a missed opportunity, which can represent a need of the stakeholder that has not been fulfilled. Pressure is where one stakeholder applies pressure to another stakeholder to convince the second stakeholder to change position. A move is where a stakeholder moves position on the issue continuum with response to another stakeholder's pressure. An offer is an offer from one stakeholder to another stakeholder in exchange for the second stakeholder changing position.

A tactic includes a set of leverages within one round. For example, sets of tactics are analyzed to see the different outcomes provided by each tactic to determine the advantages of each tactic and corresponding set of leverages. A strategy is a set of tactics. Each strategy is associated with a basecase or a scenario. In some cases, the strategies are also known as courses of action (COAs).

The outcome of a negotiation includes a set of new positions and proposals for each stakeholder in each negotiation round. For example, the outcome could include multiple rounds. For each round, the outcome would include the corresponding positions and proposals of each stakeholder in each round. In the exemplary embodiment, the negotiation takes place over a series of rounds. In each round, one or more tactics are applied and the positions of various stakeholders may change based on the tactics and corresponding leverages used.

Within one issue, the decision space may be represented as a portfolio of: [the basecase+all possible strategies of the basecase] and [scenario_i+all possible strategies of scenario_i].

The methods and systems described herein use a data generation process (DGP). The DGP takes the input of the initial data and generates an outcome for the negotiation. The DGP provides methods to apply tactics to determine the alternative multiple round outcome of negotiations by taking advantage of the corresponding sets of leverages. The methods and systems use the DGP to generate tactics and strategies that generate desired outcomes of the negotiations through repeated simulation analysis, also known as autosolving.

In the exemplary embodiment, the DMA computer system is configured to analyze a decision space to determine the potential outcomes and the courses of action (COAs) or strategies to achieve those outcomes. In some embodiments, the DMA computer system is configured to assess single issue shaping outcomes to determine COAs of alternative future branches and sequels. The DMA computer system is also configured to evaluate multiple issue outcomes and COAs for alternative futures in view of political, military, economic, social, information, infrastructure, physical environment, and time information. The DMA computer system is configured to generate robust plans based on uncertainty, exogenous shocks, adversarial behavior, and changing alternative futures.

In the exemplary embodiment, the DMA computer system determines an issue, a plurality of stakeholders, and their initial positions. The DMA computer system generates a plurality of rounds based off of the initial data, where each round may either be applied to the initial conditions or it may be applied to the stakeholder positions in later rounds. The DMA computer system determines which series of tactics achieve which user-defined end-state outcomes. Then the DMA computer system generates strategies based on those series of tactics. In some embodiments, the DMA computer system changes the basecase settings or adds one or more scenarios and re-runs the tactics to determine how the results changed.

In the exemplary embodiment, the DMA computer system determines an issue based on a plurality of data. The plurality of data may include, but is not limited to, goals, constraints, tasks, assets, timeline, facts, and assumptions. This data may be based on historical data, personal observations, research, private and publically available data, and other sources. In some embodiments, an issue is a situation or a negotiation that the user desires to be resolved. In the exemplary embodiment, the DMA computer system determines the plurality of stakeholders associated with the issue based on the plurality of data.

In the exemplary embodiment, an issue has a plurality of stakeholders, individuals and/or entities that are involved. Some stakeholders may be integral to the issue, while others are peripheral to the issue. Many stakeholders may be analyzed because a stakeholder that appears to be peripheral might actually affect the issue if influenced in a specific manner. Each stakeholder has a position. The stakeholder may be positively or negatively inclined in regard to the issue. This may be represented numerically, such as with a percentage. For example if the issue is a negotiation for a sale, the stakeholder may be 25% inclined to allow the sale to proceed, wherein the higher the percentage is, the more favorably inclined the stakeholder is. In this example, the issue continuum represents the likelihood to be inclined to support the sale of the company, with one extreme of the continuum representing not being willing to sell and the other extreme representing being completely behind selling, which the various stakeholders landing somewhere between those two extremes. In some embodiments, the issue is defined by the user. In other embodiments, the issue is determined by the DMA computer system based on the plurality of data. In the exemplary embodiment, the DMA computer system determines a plurality of initial positions for the plurality of stakeholders based on the plurality of data.

In the exemplary embodiment, the DMA computer system generates a plurality of outcomes for the issue based on the plurality of stakeholders and the plurality of initial positions. Each outcome is based on a strategy that includes one or more actions. The outcomes tests what occurs when different actions are taken or occur. For example, what happens if stakeholder A is approached in a hard manner, what happens if stakeholder A is approached in a friendly manner, and what happens if stakeholder B is approached before stakeholder A? For each stakeholder, the DMA computer system has a plurality of information about how that stakeholder reacts. Each stakeholder's perception is generated based on its current preference of the issue, its importance, and the corresponding group importance. The DMA computer system uses this information to generate tactics based on how the stakeholders would react when certain actions are taken. Each tactic also includes a plurality of actions that occur in a round, which are associated with at least some of the plurality of stakeholders. During a round, one or more of the positions of the plurality of positions of the plurality of stakeholders' changes based on at least one of the one or more actions.

In the exemplary embodiment, the DMA computer system determines at least one strategy based on the plurality of tactics. A strategy is a series of steps or actions to reach a particular outcome. A “winning” strategy is the strategy that leads to the goal outcome. Some strategies do not lead to the goal outcome.

In some embodiments, the DMA computer system receives a plurality of data from a plurality of sources. These sources may be external data resources including, but not limited to, publically available databases, governmental databases, social media information and messages, subject matter expert reports and papers, and news articles. In some further embodiments, the DMA computer system converts the plurality of data into a common format prior to using it.

In some embodiments, the DMA computer system receives one or more user preferences for the issue from the user. The DMA computer system ranks the plurality of strategies based on the one or more user preferences, including user risk appetite using multiple criteria decision-making approaches. The DMA computer system uses the ranked plurality of strategies to determine the at least one strategy. For example, a user preference may be that the user wants the negotiation to be quick; therefore, the plurality of strategies is ranked on how quickly they reach the goal.

In some embodiments, the DMA computer system analyzes the plurality of strategies to determine one or more adjustments to at least one of the plurality of stakeholders and the plurality of initial positions. The DMA computer system generates a second plurality of strategies for the issue based on the updated plurality of stakeholders and the updated plurality of initial positions. In some further embodiments, the DMA computer system applies one or more of the plurality of actions to the positions of the stakeholders to determine one of more results includes updated positions of the stakeholders. The one or more results are used as inputs for a subsequent simulation round.

In still further embodiments, the DMA computer system determines a plurality of leverages based on the plurality of rounds of strategy generation. Leverages are influences that change the position of one or more stakeholders. Some leverages may be hidden and some may be misperceptions. The DMA computer system ranks the plurality of leverages based on one or more criteria. The one or more criteria may include, but is not limited to, a magnitude of the leverage, a consistency of the leverage, and an effective power of a stakeholder associated with the leverage. In these embodiments, the DMA computer system filters the ranked plurality of leverages. For example, the DMA computer system may filter out all but a top ranked number of leverages. The DMA computer system determines a plurality of tactics associated with the remaining leverages. These tactics include plurality of actions or steps required to achieve the leverage, such as approaching and making offers to certain individuals in a certain order.

The DMA computer system ranks the plurality of tactics and determines the strategy based on the ranked plurality of tactics. The DMA system ranks the plurality of tactics based on a total number of stakeholders involved, a number of stakeholders moved, and a number of drivers, who execute leverages against other stakeholders, required.

In some embodiments, the DMA computer system uses a brute force technique to generating strategies by cycling through every potential combination of leverages and actions. In other embodiments, the DMA computer system generates strategies based on a plurality of rules that may be based on performance. For example, a strategy may be discarded if the strategy does not move one or more stakeholders in the proper direction to reach the desired outcome. In still other embodiments, the DMA computer system uses machine learning reinforcement. In these embodiments, the DMA computer system relies on existing rules and past generated strategies as a guide to determining subsequent strategies.

In an enhancement for generating strategies and scenarios, an advanced horizon scanning and deep horizon scan searching system described herein is used to help to design experiments to determine potential alternative scenarios that may be used with this system to achieve a goal. The advanced horizon scanning and deep searching system uses smart sampling of inputs to figure out how outputs depend on different inputs.

For the advanced horizon scanning and deep searching system, the DMA computer system uses advanced horizon scanning to diagnose deep uncertainty surrounding human behavior on any issue being analyzed. The DMA computer system uses alternative futures algorithms to explore and identify possible unknown scenarios that can be significantly change anticipated outcomes. The DMA computer system advanced horizon scanning uses advanced AI, computational boosting, and second-order Markov chain simulation techniques. The DMA computer system uses the advanced horizon scanning to provide early warning on any issue for significant tipping points. More specifically, the advanced horizon scanning is configured to identify unknown scenarios, tipping points and/or triggers that can significantly change anticipated and/or basecase outcomes. The advanced horizon scanning generates possible alternative futures across deep uncertainty. In this advanced horizon scanning enhancement, the DMA computer system executes a plurality of runs, where each run is an AI generated ‘what if” scenario to scan for what potential unknown downside risks or upside opportunities are on the horizon. Once the advanced scan is complete, the DMA computer system is configured to explore if, where, and exactly how the various scans are different.

In the advanced scanning embodiment, the DMA computer system shocks each stakeholder's selected attributes from 0 to 1. Examples of attributes include, but are not limited to, influence, importance, and/or group influences with particular statistic distributional properties.

In the advanced horizon scanning embodiment, the DMA computer system executes a plurality of runs for the scenarios using the shocked input. The number of runs in the plurality of runs may range depending on the available processing resources and/or user preferences. In some embodiments, the number of runs may range from 1000 to 100,000 runs. In other embodiments, the number of runs may exceed this range. The DMA computer system categorizes and bins the executed runs based upon their goal percentage result. The DMA computer system categorizes each executed run into a bin based upon the goal percentage associated with the run. These categorized binned results are then used during the initial step of the deep search. In at least one embodiment, the DMA computer system supports 11 bins divided by 10% of the goal percentage. In other embodiments, the DMA computer system may support other numbers of bins and corresponding goal percentage or other KPIs depending on user preferences and/or needs.

In the advanced horizon scanning and deep searching embodiment, the DMA computer system also performs deep searching on the scenarios to find out which categories of scenario inputs leads to the corresponding goal percentages. In at least one embodiment, the DMA computer system bases the deep search on the scanning results and the corresponding goal percentage bins. The user and/or the DMA computer system chooses at least one target bin for deep searching. For deep searching, the DMA computer system performs boosting and key attribute extraction in a top-down process.

For boosting, the DMA computer system statistically boosts the runs that fall into the categorized target bin(s). The output is a range list for all stakeholders' attributes statistical distributional results for that categorized bin. For example, if there are 33 stakeholders in this categorized bin and two attributes are being boosted, then the length of this result range list is 66 (33*2). For key attribute extraction, the DMA computer system uses the range list from boosting to extract the key attribute ranges that are sufficient to generate the target goal percentage. The key attribute ranges may be a subset of the range list from boosting. This outputs the statistical distributional ranges for the key attributes to be able to achieve the desired goal percentage.

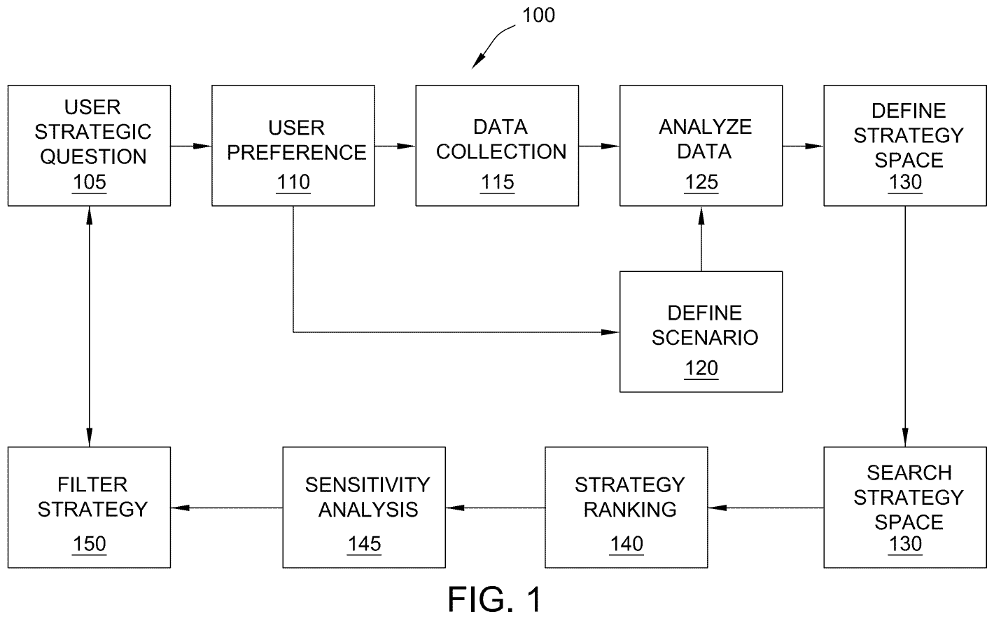

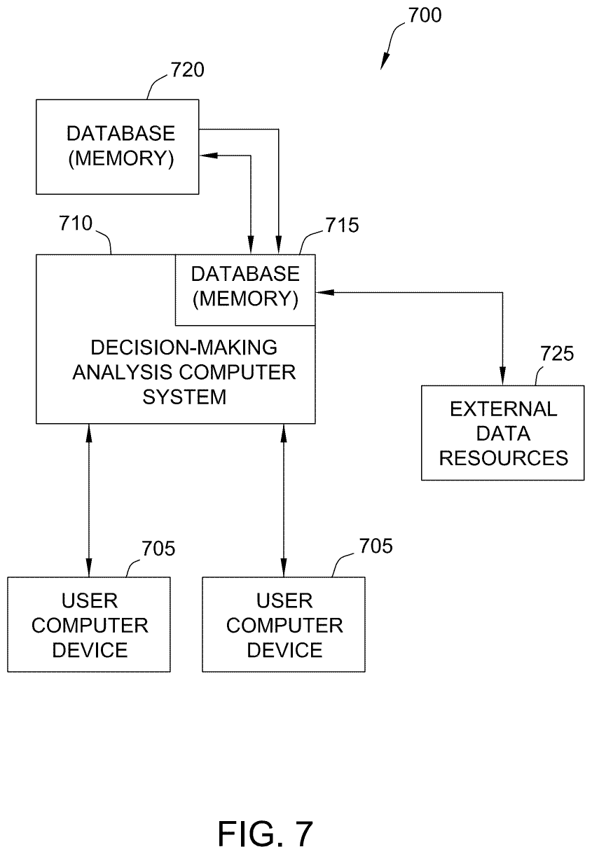

FIG. 1 illustrates a data flow diagram for a process 100 for determining optimal paths for multi-party situations through high-level simulation in accordance with one embodiment of the disclosure. In the exemplary embodiment, process 100 is performed by a decision-making analysis (DMA) computer system, such as the DMA computer system 710 described in FIG. 7.

In the exemplary embodiment, the DMA computer system 710 is configured to analyze a decision space to determine the potential outcomes and courses of action (COAs) to achieve those outcomes. In some embodiments, the DMA computer system 710 is configured to assess single issue shaping outcomes to determine COAs of alternative future branches and sequels. The DMA computer system 710 is also configured to evaluate multiple issue outcomes and COAs for alternative futures in view of political, military, economic, social, information, infrastructure, physical environment, and time information. The DMA computer system 710 is configured to generate robust plans based on uncertainty, exogenous shocks, adversarial behavior, and changing alternative futures.

In the exemplary embodiment, the DMA computer system 710 determines the user strategic question 105. This is the question or situation that the user wants to determine what the possible outcomes are. Effectively, the user strategic question 105 asks what is going to happen, when it is going to happen, and how is it going to happen. Examples of user strategic questions 105 include should I adopt another dog, who should I give raises to, how can I get the board of Company A to sell me the company, how can I get my friend to loan me his convertible, and will there be a negotiated agreement between party A and party B? Other example user strategic questions 105 include, but are not limited to, how do we negotiate trade tariffs with countries A and B, how do we negotiate the sale of airplanes to country C, can we convince country D to release X political prisoner, how do we get the speed limit raised to 75 mph on Interstate highways, and how do we convince the federal/state government to legalize the use of one or more substances?

In the exemplary embodiment, the DMA computer system 710 asks the user a series of descriptive questions to gather information to formulate the question. In some embodiments, the DMA computer system 710 determines what the actual user strategic question 105 is based on the user's answers. In other embodiments, the DMA computer system 710 outright asks the user which question that they want analyzed.

In the exemplary embodiment, the DMA computer system 710 receives the user preferences 110. The user preferences 110 represent the user's preferences in negotiating an outcome and evaluation metrics for determining a desired solution. Examples of user preferences 110 may include, but are not limited to, risk appetite, number of rounds desired, whether a consensus is desired, preferences on tactics or leverages used (aka stakeholders that will not interact with each other), and which evaluation metrics to use in evaluating strategies. In some embodiments, the DMA computer system 710 uses the answers to the previously asked questions to determine the user preferences 110. In other embodiments, the DMA computer system 710 asks the user another series of questions to determine the user preferences 110. The user preferences 110 may include, but are not limited to, goals, constraints, tasks, assets, timeline, facts, and assumptions that are relevant to the user's specific negotiation.

In the exemplary embodiment, the DMA computer system 710 performs data collection 115 by determining the stakeholders involved, their corresponding groups, group influence, position, influence, and importance. In the exemplary embodiment, the DMA computer system 710 receives the information for the data collection 115 from the user. In these embodiments, the DMA computer system 710 verifies the information provided using other sources. In some embodiments, the DMA computer system 710 analyzes other issues to determine the stakeholders. In other embodiments, the DMA computer system 710 consults with subject matter experts to perform the data collection 115. This data collection 115 may be based on historical data, personal observations, research, private and publically available data, and other sources.

In the exemplary embodiment, the DMA computer system 710 compiles the user provided information to define one or more scenarios 120 for analysis. Each scenario includes the initial positions of the stakeholders and is based on one or more changes to those initial positions. A scenario changes the basecase for analysis, such as by removing or adding stakeholders or changing one or more properties of the existing stakeholders. Effectively, each scenario asks a “what-if” question. What if this happens? Or if this outside force affects the negotiations? In some embodiments, the DMA computer system 710 defines the scenario 120 based on one or more pre-defined scenarios. In other embodiments, the DMA computer system 710 defines the scenario 120 based on the results of past scenarios and/or user preferences. Environmental factors are also considered in the scenarios, e.g., what happens if the costs of the materials to make the company's gizmos goes up, what happens if the amount that those gizmos can be sold for goes up or down, and what happens if one of these four individuals leaves the company?

In the exemplary embodiment, the DMA computer system 710 analyzes the data 125 from the data collection 115 and applies it to the defined scenarios 120. In the exemplary embodiment, the DMA computer system 710 analyzes the basecase to determine a baseline result. Whether or not there is a solution to the basecase that reaches the desired outcome that fits within the user preferences 110. For example, will company A sell to company B? In some embodiments, if there is a baseline solution, then the DMA computer system 710 presents that solution to the user. In some of these embodiments, the DMA computer system 710 ends process 100 after finding a successful baseline solution.

The DMA computer system 710 analyzes the data 125 to determine actions and/or proposals that would need to be performed or used to achieve the desired user-defined outcome. In the exemplary embodiment, subsequent to determine the basecase, the DMA computer system 710 analyzes the one or more defined scenarios 120. In the exemplary embodiment, the DGP is performed on the initial data of the basecase. The DGP generates a multi-round negotiation outcome, which includes stakeholder positions after the negotiation and the proposals to reach that outcome. Then the DGP also generates multi-round negotiation outcomes for each of the scenarios 120.

In some embodiments, the DMA computer system 710 uses a brute force technique to generate multi-round negotiation outcomes by cycling through every potential combination of leverages and actions. In other embodiments, the DMA computer system 710 generates multi-round negotiation outcomes based on a plurality of rules that may be based on performance. For example, a strategy or tactic may be discarded if the strategy or tactic does not move one or more stakeholders in the proper direction to reach the desired outcome. In still other embodiments, the DMA computer system 710 uses machine learning reinforcement. In these embodiments, the DMA computer system 710 relies on existing rules and past generated strategies and tactics as a guide to determining subsequent strategies.

In the exemplary embodiment, the DMA computer system 710 defines the strategy space 130 for the issue. The DMA computer system 710 combines a plurality of tactics into a strategy to examine the decision space. Each strategy includes a set of tactics/steps and/or actions taken to achieve a goal. The steps and/or actions may include, but are not limited to, approaching different stakeholders, offering different things to different stakeholders to change their position, having a stakeholder change their own position, having a stakeholder apply pressure to another stakeholder, environmental changes, and anything that might move the stakeholder's position. The tactics test what occurs when different actions are taken or occur. For example, what happens if stakeholder A is approached in a hard manner, what happens if stakeholder A is approached in a friendly manner, what happens if stakeholder B is approached before stakeholder A, and what happens if stakeholder A makes a different proposal to stakeholder B? For each stakeholder, the DMA computer system 710 uses the properties about the stakeholder to determine how the stakeholder will react. What is important to that stakeholder and who does that stakeholder admire, get along with, dislike, or oppose.

The DMA computer system 710 uses this information to generate strategies, which are combinations of tactics, based on how the stakeholders would react when certain actions are taken. Based on the step taken, the DMA computer system 710 determines the change in position of one or more of the stakeholders. The DMA computer system 710 generates a plurality of rounds of actions, where in each round different actions are applied to achieve the result. The different tactics are run in different combinations until each chain of tactics either ends in successfully reaching the goal or the positions of the stakeholders are such that the goal is effectively unachievable.

For example, in a negotiation to sell a company, four individuals, A, B, C, and D, need to be convinced to sell the company. Different strategies are generated for how to approach the four individuals. In one strategy, each are approached in A-B-C-D order. In another strategy, B is approached first. In a further strategy, A & B are approached together. In yet another strategy, different positions are offered. For each strategy, after each step, the different positions of the four individuals are recalculated. In some strategies, the goal may be achieved quickly, in other strategies; it may take a large number of steps.

The DMA computer system 710 then runs all potential strategy and tactic combinations to search 135 the strategy space to determine which strategies worked and achieved the desired outcome, which strategies got to a point near the desired outcome, and which would not achieve the desired outcome.

In the exemplary embodiment, the DMA computer system 710 analyzes the strategy space 130 to rank 140 the strategies based on the user preferences 110. For example, the user may state that speed is important. In this example, the strategies are ranked 140 based on the speed to achieve the desired outcome based on the number of rounds of negotiation, the number of individuals that need to be approached, and/or the number of steps. In some embodiments, the strategies are ranked based on the confidence and likelihood the individual strategies are to occur and/or to succeed. Other ranking criteria may include, but are not limited to, feasibility, acceptance, distinguishability, completeness, whether or not a consensus is reached, number of stakeholders agreeing, etc.

Based on the plurality of strategies, the DMA computer system 710 analyzes the facts and assumptions of each strategy using sensitivity analysis 145. The DMA computer system 710 may use the results of the sensitivity analysis to generate a plurality of alternative scenarios 120 based on strategies to be considered. The plurality of alternative scenarios 120 are configured to analyze different potential alternative futures. These alternative futures may be based on subjecting stakeholder input positions to internal and external influences and shocks. These alternative futures are compared to the base case. The DMA computer system 710 then identifies different outcomes and triggers for other alternative future scenarios based on the comparisons. This includes analyzing each strategy to determine how robust the strategy is based on changes to initial data. In some embodiments, sensitivity analysis 145 is only performed on a percentage of the top-ranking strategies.

In some embodiments, the DMA computer system 710 filters 150 the strategies based on the results of the sensitivity analysis 145 and the user preferences 110. The DMA computer system 710 presents the results to the user. In some embodiments, the user changes the user strategic question 105 based on the results and re-initiates process 100 based on the updated user strategic question 105. In other embodiments, the DMA computer system 710 automatically adjusts the user strategic question for another iteration of process 100.

In some embodiments, process 100 repeats for a plurality of rounds as additional scenarios and strategies are generated based on updated user preferences 110. In this embodiment, the DMA computer system 710 continues to run iterations of the process 100 of generating strategies and scenarios and for updating inputs based on the scenario results. In the exemplary embodiment, the DMA computer system 710 runs k rounds of analysis, where k is set by the user or determined automatically by the DMA computer system 710 as a part of process 100.

After the k number of rounds, the DMA computer system 710 determines a plurality of leverages based on drivers and stakeholders, where the stakeholders are needed for the negotiation and the drivers are what affects or moves those stakeholders and can be convinced to work or act for the user. Leverages are influences that change the position of one or more stakeholders, but may be misperceived by one or more of the stakeholders, where an individual's public image portrays one thing and then actually changes position based on another. In the exemplary embodiment, the DMA computer system 710 compares and ranks the different leverages by magnitude (how much did is cause to move), consistency (did is occur every round), and stakeholder effective power (how effective is this stakeholder at moving others and a being an influencer and how important is the stakeholder to the negotiation process). In other embodiments, the DMA computer system 710 analyzes the leverages every round and generates the next step of strategies based on the analyzed leverages.

Based on the rounds, the DMA computer system 710 detects one or more tactics (also known as a strategy), which are combinations of leverages to achieve results. The DMA computer system 710 ranks these combinations based on one or more of the number of stakeholders and drivers involved, the number of stakeholders involved, the number of drivers involved, and the number of leverages used. The DMA computer system 710 then generates one or more strategies based on the rankings.

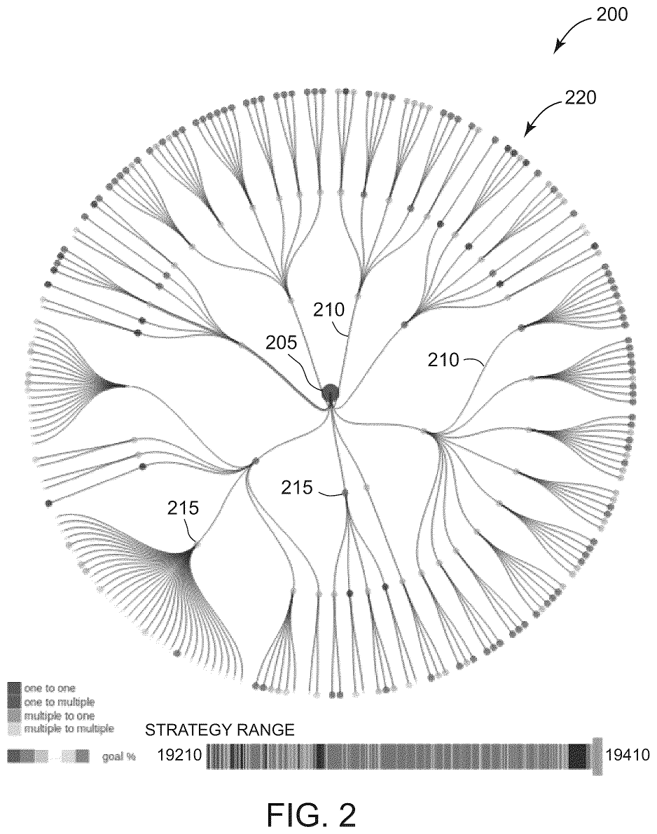

FIG. 2 illustrates a graphical view 200 of the data flows of a plurality of tactics in accordance with the process 100 shown in FIG. 1. In the exemplary embodiment, view 200 is a graphical representation of a plurality of strategies and tactics being searched by DMA computer system 710 as shown in process 100, such as those created in Steps 125 and 130 (shown in FIG. 1) in process 100. The tactics comprise a plurality of proposal types (aka leverages) that occur during a single round or across multiple rounds of negotiation. The proposal types include: leverages, pressures, moves, and offers. The strategies comprise a plurality of tactics which make up the strategy space search.

The tactics test what will occur when different actions are taken during a round. For example, what happens if stakeholder A is approached in a hard manner, what happens if stakeholder A is approached in a friendly manner, and what happens if stakeholder B is approached before stakeholder A? For each stakeholder, the DMA computer system 710 (shown in FIG. 7) stores a plurality of information about how that stakeholder reacts. What is important to that stakeholder and who does that stakeholder admire, get along with, dislike, or oppose. The DMA computer system 710 uses this information to generate strategies based on how the stakeholders would react when certain tactics are used.

In the exemplary embodiment, the plurality of tactics starts at an initial position 205, which is similar to initial basecase data. This initial position 205 includes starting positions for all of the stakeholders based on the user preferences 110 and the data collection 115 (both shown in FIG. 1). In the first simulation, the DMA computer system 710 applies a plurality of different tactics 210 to the initial position 205. For each simulated negotiation action, the DMA computer system 710 determines the new situation based on the tactic 210. In addition, stakeholders are not stationary like chess pieces and may take actions to oppose one or more of the stakeholders. For example, one of the four stakeholders (A, B, C, & D) may wish to have someone else buy the company, that stakeholder may then oppose one or more of the actions of another stakeholder or may take direct adversarial actions. The DMA computer system 710 will include these potential adversarial actions in its generation of sequential tactic and strategy branches.

At the end of the first simulation, each new situation is represented by node 215. The node 215 represents where the tactic 210 has generated a result, where the result may or not meet either the success conditions or the failure conditions. A final node 220 represents where the tactics 210 have reached an end point where there are no further actions available or desired. For example, a final node 220 may represent where all of the stakeholders have agreed to sell the company. Another final node 220 may represent where one or more of the stakeholders have completely walked away from the negotiation.

For each, the associated tactics 210 are combined to generate the strategies. The view 200 shown in FIG. 2 illustrates only three steps are being performed. In the exemplary embodiment, any number of rounds and tactics may be determined based on the positions of the stakeholders, the amount of time available, and the time to complete each action, creating deeper search trees with multiple nodes and children branches.

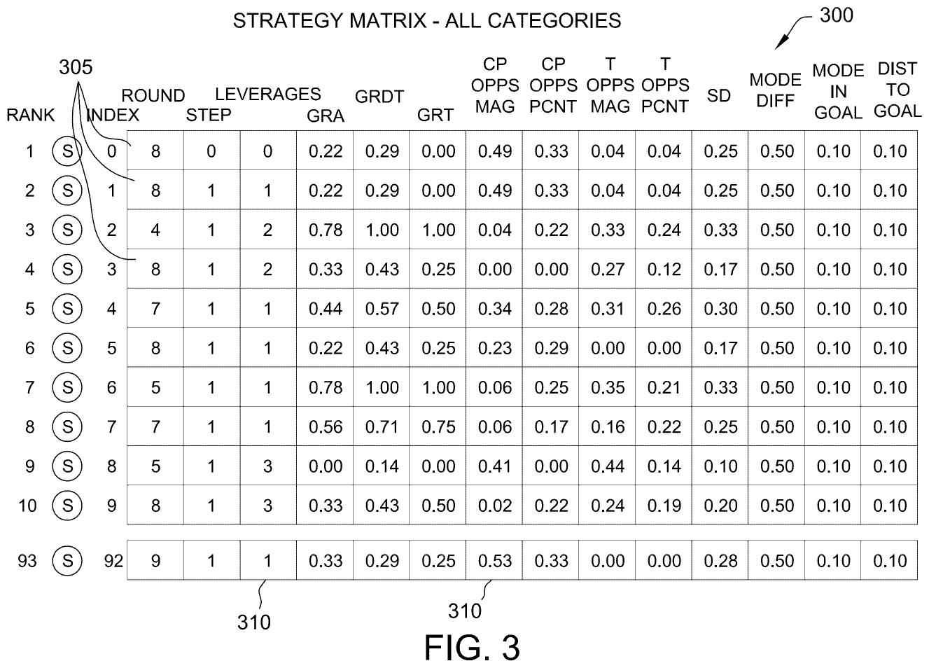

FIG. 3 illustrates a graphical view of a matrix 300 showing the ranking of strategies based on criteria in accordance with the process 100 shown in FIG. 1. In the exemplary embodiment, the plurality of strategies is generated in Steps 125 and 130 of process 100 (all shown in FIG. 1). In the exemplary embodiment, the plurality of strategies is each ranked by the DMA computer system 710 given the simulated outcomes of each strategy.

The DMA computer system 710 ranks the plurality of strategies based on achieving the desired outcome, the tactics and strategies used to achieve those goals, and the likelihood and/or confidence that those tactics and strategies would achieve the desired outcome. Other criteria for ranking may include, but is not limited to, one or more of the user preferences 110 (shown in FIG. 1), as well as the percentage of the desired outcome completed, number of moves by the user and/or stakeholders, opposition moves, threats, coalitional standard deviations, suitability, feasibility, acceptance, distinguishability and/or completeness of the corresponding strategy.

For illustration purposes, matrix 300 includes a plurality of rows 305, which each represent a different strategy. Each column 310 includes information about the strategy such as, but not limited to, number of rounds, goal percentage, delta goal, standard deviation, average number of user moves, average number of stakeholder movers, and other information as defined by the user and used to rank the plurality of users. In FIG. 3, each column data block is also rated against predetermined thresholds to determine how different attributes of each strategy rates. For example, strategy 3 took 4 rounds, while strategy 4 took 8 rounds. The user determines which fields are important and which are not and the DMA computer system 710 uses those determinations in the ranking of the strategies. In some embodiments, the fields are determined automatically by the DMA computer system 710.

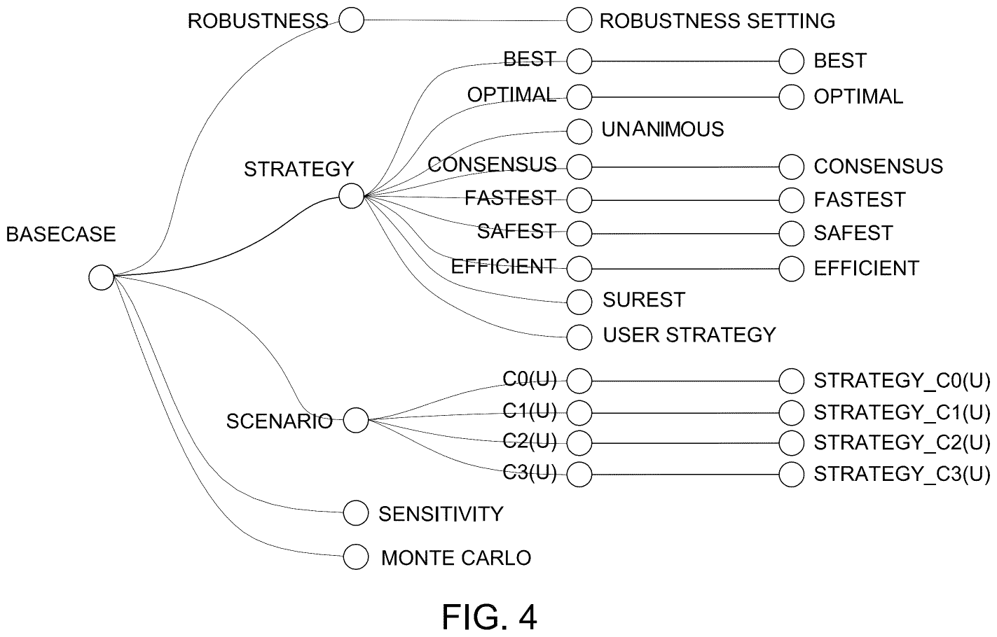

FIG. 4 illustrates a graphical view of a flowchart of analyzing alternative future scenarios generated using the process 100 shown in FIG. 1. In the exemplary embodiment, the DMA computer system 710 generates a plurality of alternative futures based on the plurality of scenarios to fully depict the decision space of the multi-party negotiation.

The DMA computer system 710 analyzes the plurality of different scenarios. Starting at a basecase, which may be similar to initial position 205 (shown in FIG. 2); the DMA computer system 710 generates different scenarios. Each analysis or issue begins with the basecase. To illustrate this view starts with a tree to which all subsequent analysis performed on a specific basecase will be appended. Robustness, Strategy, Scenario, Sensitivity and Monte Carlo are all types of analysis performed on a single basecase. The DMA computer system 710 or the user may create multiple strategies and are then categorized into the different types, such as Best, Optimal, Unanimous, Efficient, Fastest, etc. to match user's input requirements. The DMA computer system 710 or the user can also create different scenarios to test how the negotiations will change under alternative circumstances, like strategies, there can be multiple scenarios. As seen above, new strategies and scenarios created will be appended to the explorer tree. Scenario Strategy refers to the use of a leverage inside a scenario analysis to find beneficial negotiation solutions, and like the strategies and scenarios, there can be multiple ones.

The best strategy is based on the user preference ranks for all categories to match the user risk appetite, goals, and constraints. The DMA computer system 710 applies the key metrics under each category to rank for best strategy. For example, if the ranking for category is: Fastest, Optimal, Efficient, Unanimous, Consensus, Safest: then the list is: Round->GRDT->Round->Step->Leverage->Mode Diff->SD->Mode to Goal->GRA->GRDT->T opps pont->T opps mag->Index. This reduces down to Round->GRDT->Step->Leverage->Mode Diff->SD->Mode to Goal->GRA->T opps pont->T opps mag->Index.

Index refers to the order of strategies based on the order that the DMA computer system 710 discovered or generated them. GRT refers to the percentage of targets out of all the targets are in the goal range. GRDT refers to the percentage of targets and drivers out of total number of drivers and targets are in the goal range. GRA refers to the percentage of stakeholders out of all stakeholders are in the goal range. Round refers to the length of the negotiation. Step refers to the number of steps needed to perform strategy. SD refers to the standard deviation of all stakeholders' positions. Mode Diff refers to the distance of the most occurring position and the second most occurring position. Mode to Goal refers to the distance of the most occurring position to the goal point. Leverage refers to the number of Client/Proxy Leverages were used in strategy. T opps pent stands for Target opportunities percent (how many ‘leverage’ proposals Target has as threats to the client stakeholders in any particular simulation run. T opps mag stands for Target opportunities magnitude-How large are ‘leverage’ proposals from Target that could potentially threaten client stakeholders in any particular simulation. One of skill in the art would understand that the strategies may be ordered, ranked, or sorted using additional methodologies to those presented herein.

In the exemplary embodiment, the different strategies may also be categorized as one or more of the following categories: optimal, unanimous, consensus, fastest, safest, efficient, surest, and user strategy.

The optimal strategy is based on analyzing, sorting, and ranking strategies in view of: GRDT: Percent of targets and drivers out of the total number of targets and drivers are in the goal range in descending order, Round: Length of negotiation in ascending order, Step: How many steps needed to perform strategy in ascending order, GRT: Percent of targets out of all the targets are in the goal range in descending order, GRA: Percent of stakeholders out of all stakeholders are in the goal range in descending order, and Index: the order of the strategy found by the DMA computer system 710 in ascending order.

The unanimous strategy is based on analyzing, sorting, and ranking strategies in view of: Mode Diff: the distance of the most occurring position and the second most occurring position in ascending order, SD: Standard deviation of all stakeholders' positions in ascending order, Mode to Goal: distance of the most occurring position to goal point in ascending order, GRT: Percent of targets out of all the targets are in the goal range in descending order, GRDT: Percent of targets and drivers out of total number of targets and drivers are in the goal range in descending order, GRA: Percent of stakeholders out of all stakeholders are in the goal range in descending order, and Index: the order of the strategy found by the DMA computer system 710 in ascending order.

The consensus strategy is based on analyzing, sorting, and ranking strategies in view of: GRA: Percent of stakeholders out of all stakeholders are in the goal range in descending order, GRDT: Percent of targets and drivers out of total number of targets and drivers are in the goal range in descending order, GRT: Percent of targets out of all the targets are in the goal range in descending order, and Index: the order of the strategy found by the DMA computer system 710 in ascending order.

The fastest strategy is based on analyzing, sorting, and ranking strategies in view of: Round: Length of negotiation in ascending order, Step: How many steps needed to perform strategy in ascending order, GRT: Percent of targets out of all the targets are in the goal range in descending order, GRDT: Percent of targets and drivers out of total number of targets and drivers are in the goal range in descending order, GRA: Percent of stakeholders out of all stakeholders are in the goal range in descending order, and Index: the order of the strategy found by the DMA computer system 710 in ascending order.

The safest strategy is based on analyzing, sorting, and ranking strategies in view of: T opps pent: percent of ‘leverage’ proposals Target has, T opps mag: magnitude of ‘leverage’ proposals from Target, GRT: Percent of targets out of all the targets are in the goal range in descending order, GRDT: Percent of targets and drivers out of total number of targets and drivers are in the goal range in descending order, GRA: Percent of stakeholders out of all stakeholders are in the goal range in descending order, and Index: the order of the strategy found by the DMA computer system 710 in ascending order.

The efficient strategy is based on analyzing, sorting, and ranking strategies in view of: Leverage: how many client/proxy leverages were used in the strategy, GRT: Percent of targets out of all the targets are in the goal range in descending order, GRDT: Percent of targets and drivers out of total number of targets and drivers are in the goal range in descending order, GRA: Percent of stakeholders out of all stakeholders are in the goal range in descending order, and Index: the order of the strategy found by the DMA computer system 710 in ascending order.

The surest strategy is based on analyzing, sorting, and ranking strategies to determine the strategy that has the highest likelihood and confidence.

The user strategy is any strategy that the user has manually added based on any other criteria.

One of skill in the art would understand that the strategies may be ordered, ranked, or sorted using additional categories to those presented herein.

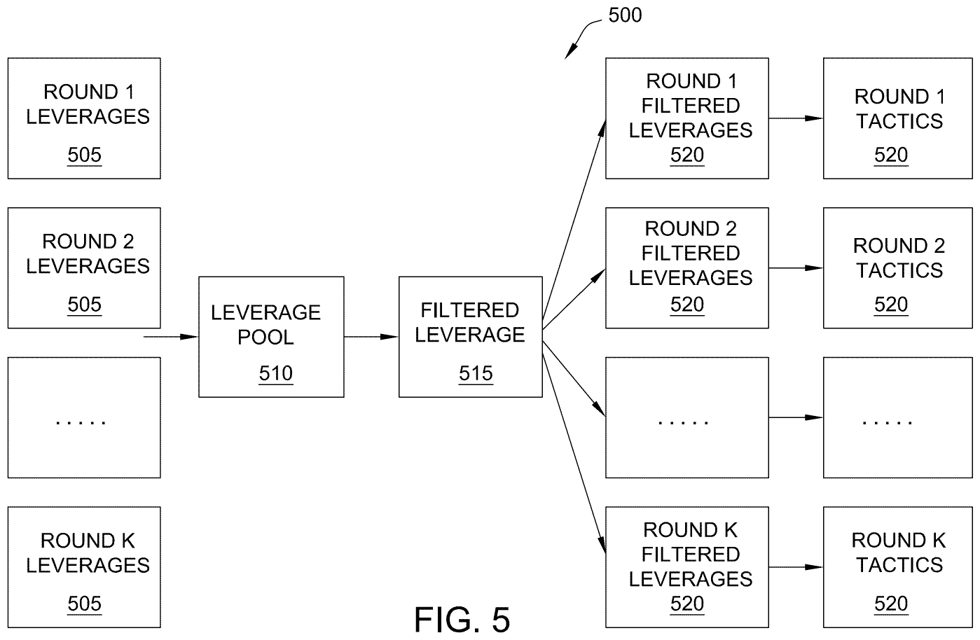

FIG. 5 illustrates a flow chart of a process 500 for determining and ranking leverages in accordance with one embodiment of the disclosure. In the exemplary embodiment, process 500 is performed by DMA computer system 710 (shown in FIG. 7).

In the exemplary embodiment, the DMA computer system 710 analyzes all of the strategies to determine different leverages. Leverages are influences that change the position of one or more stakeholders, but may be misperceived by one or more of the stakeholders, where an individual's public image portrays one thing and then actually changes position based on another. The DMA computer system 710 determines these leverages based on how the different stakeholders moved in the different strategies. The DMA computer system 710 determines the leverages based on changes to the stakeholder position taking into account the stakeholder's previous position and properties, such as, influence and importance, to determine the effect of moves, leverages, offers, and pressures. For example, A moved from being 10% likely to sell to 60% likely to sell when B was approached first. Another example is that C moves to being 75% likely to sell when D reaches 50%. The DMA computer system 710 determines the leverage based on the actions taken prior to the change in position. In some embodiments, a leverage may be based on an action that took place several actions before the present time. In other embodiments, a leverage is based on the action that occurred directly before. In still other embodiments, a leverage is a reaction from a third-party that affects an individual stakeholder's position.

As described above, in some embodiments, process 100 (shown in FIG. 1) repeats for a plurality of rounds as additional scenarios and corresponding strategies are generated. In this embodiment, the DMA computer system 710 continues to run iterations of the process 100 of generating strategies and updating inputs based on the strategy results. In the exemplary embodiment, the DMA computer system 710 runs k rounds of analysis, where k is set by the user or determined automatically by the DMA computer system 710 as a part of process 100.

After the k number of rounds, the DMA computer system 710 determines a plurality of potential leverages 505 based on drivers and stakeholders, where the stakeholders are needed for the negotiation and the drivers are what affects or moves those stakeholders and can be convinced to work or act for the user. The plurality of potential leverages 505 used in each round are determined based on the tactics and strategies identified by the DMA computer system 710 used in the corresponding round. In the exemplary embodiment, the DMA computer system 710 stores the plurality of leverages 505 in a leverage pool 510. The DMA computer system 710 analyzes each of the leverages 505 based on magnitude (how much did is cause to move), toGoalPoint (how far away from the goal after applying this leverage), toGoalRange (at what range of distance from the goal does this leverage work), towardsGoal (does this move closer to the goal), consistency (did is occur every round), and stakeholder effective power (how effective is this stakeholder at moving others and being an influencer and how important is the stakeholder to the negotiation process).

In the exemplary embodiment, DMA computer system 710 ranks the plurality of leverages 505 in the leverage pool 510 based on the magnitude, consistency, stakeholder effective power, and end position of the corresponding leverage (i.e., distance to the goal outcome). DMA computer system 710 then filters 515 the leverage pool 510 to identify the top n leverages 505, where n is a predefined number set by the user, such as 10. Each filtered leverage 520 is associated with a different tactic 525. The DMA computer system 710 groups the filtered leverages by round. Then the round-based filtered leverages 520 for each round are converted into round specific tactics 525.

Each tactic 525 is ordered by the number of drivers and the number of stakeholders involved, then by the number of stakeholders involved and then by the number of drivers involved in the tactic 525. In the exemplary embodiment, the DMA computer system 710 generates a strategy to apply the tactics 525 in the determined order, where the Round 1 tactics 525 are performed first, followed by the Round 2 tactics 525, through the Round k tactics 525.

In other embodiments, the DMA computer system 710 analyzes the leverages every round and generates the next round of strategies based on the analyzed leverages based upon machine learning approaches.

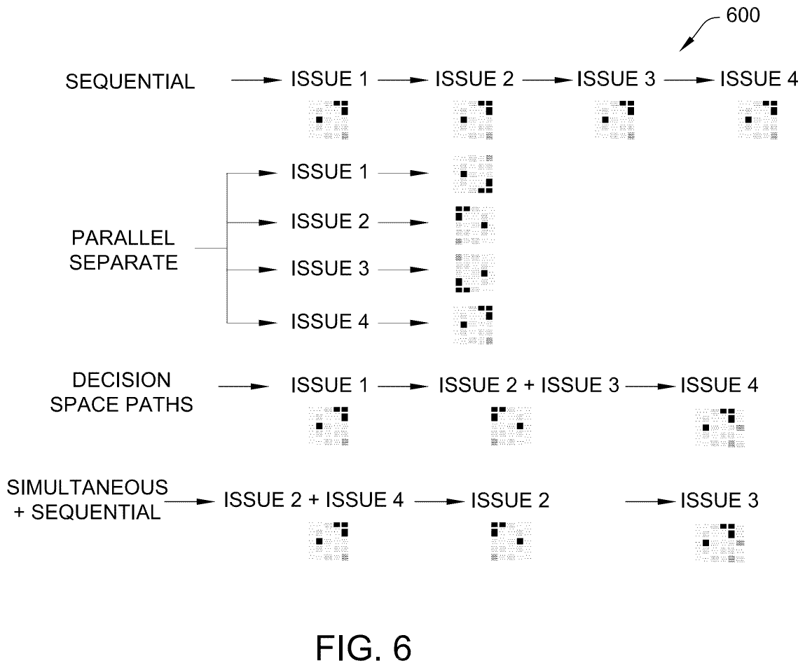

FIG. 6 illustrates a graphical flow chart of a process 600 for analyzing multiple issues in accordance with the process 100 shown in FIG. 1. In some embodiments, multiple issues are analyzed using process 100. Each of these issues may be analyzed by DMA computer system 710. In some cases, the different issues are analyzed sequentially, where each issue is resolved in order, such that when DMA computer system 710 finished analyzing one issue, it analyzes the next based on the results of the first. In other cases, the issues are analyzed in parallel where each one is analyzed based on the same starting conditions. In still other cases, the issues are analyzed in a combination of simultaneously and sequentially, where one issue may be analyzed, then two in parallel and then another based on the results of the two in parallel. In these embodiments, the different methods of analyzing the issues are compared to determine the best order to resolve the issues in.

FIG. 7 depicts a simplified block diagram of an exemplary decision-making analysis (DMA) system 700 for determining optimal paths for multi-party situations through high-level simulation based on the process 100 shown in FIG. 1. In the exemplary embodiment, system 700 may be used for generating and analyzing strategies to determine optimal courses of action. As described below in more detail, a decision-making analysis (“DMA”) computer system 710 (also known as a DMA computer device 710), may be configured to (i) determine an issue based on a plurality of data; (ii) determine a plurality of stakeholders for the issue based on the plurality of data; (iii) determine a plurality of initial positions for the plurality of stakeholders based on the plurality of data; (iv) generate a plurality of strategies for the issue based on the plurality of stakeholders and the plurality of initial positions; and (v) determine at least one strategy based on the plurality of strategies, as described herein.

In the exemplary embodiment, user computer devices 705 are computers that include a web browser or a software application, which enables user computer devices 705 to access remote computer devices, such as DMA computer system 710, using the Internet or other network. More specifically, user computer devices 705 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, a cloud connection, and a cable modem. User computer devices 705 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices.

A database server 715 is communicatively coupled to a database 720 that stores data. In one embodiment, database 720 may include user strategic questions 105, user preferences 110, scenarios 120 (all shown in FIG. 1), leverages 505 (shown in FIG. 5), strategies, and tactics. In the exemplary embodiment, database 720 is stored remotely from DMA computer system 710. In some embodiments, database 720 is decentralized. In the exemplary embodiment, a user, may access database 720 via user computer device 705 by logging onto DMA computer system 710, as described herein. In other embodiments, a user may directly access the DMA computer system 710.

In the exemplary embodiments, DMA computer system 710 is also in communication with a plurality of external data sources 725 through which DMA computer system 710 is able to determine user strategic questions 105, user preferences 110, and potential scenarios 120. External data resources 725 include, but are not limited to, publically available databases, governmental databases, social media information and messages, subject matter expert reports and papers, news articles, and any other information necessary to perform the steps described herein.

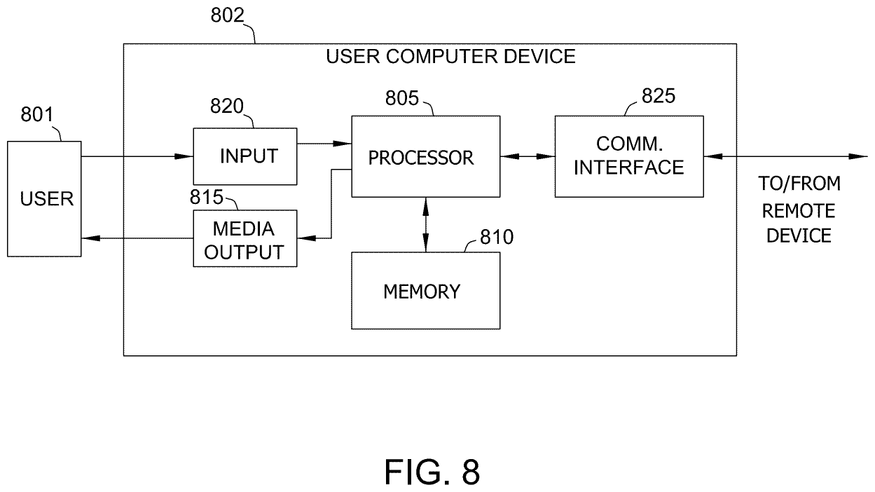

FIG. 8 depicts an exemplary configuration of client computer device, in accordance with one embodiment of the present disclosure. User computer device 802 may be operated by a user 801. User computer device 802 may include, but is not limited to, user computer device 705 and DMA computer system 710 (both shown in FIG. 7). In some embodiments, user computer device 802 is a part of a cloud client server deployment. User computer device 802 may include a processor 805 for executing instructions. In some embodiments, executable instructions may be stored in a memory area 810. Processor 805 may include one or more processing units (e.g., in a multi-core configuration). Memory area 810 may be any device allowing information such as executable instructions and/or transaction data to be stored and retrieved. Memory area 810 may include one or more computer readable media.

User computer device 802 may also include at least one media output component 815 for presenting information to user 801. Media output component 815 may be any component capable of conveying information to user 801. In some embodiments, media output component 815 may include an output adapter (not shown) such as a video adapter and/or an audio adapter. An output adapter may be operatively coupled to processor 805 and operatively coupleable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 815 may be configured to present a graphical user interface (e.g., a web browser and/or a client application) to user 801. A graphical user interface may include, for example, an interface for viewing potential strategies. In some embodiments, user computer device 802 may include an input device 820 for receiving input from user 801. User 801 may use input device 820 to, without limitation, to input user preferences 110 (shown in FIG. 1).

Input device 820 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 815 and input device 820. In some embodiments, media output component 815 and input device 820 provide augmented or virtual reality interactions to the user 801. These components 815 and 810 may include virtual and augmented reality hardware. For example, the media output component 815 may be a part of one or more pieces of headgear worn by the user 801 and the input device may be a wearable device capable of recognizing user gestures for input.

User computer device 802 may also include a communication interface 825, communicatively coupled to a remote device such as DMA computer system 710 or external data resources 725 (shown in FIG. 7). Communication interface 825 may include, for example, a wired or wireless network adapter and/or a wireless data transceiver for use with a mobile telecommunications network.

Stored in memory area 810 are, for example, computer readable instructions for providing a user interface to user 801 via media output component 815 and, optionally, receiving and processing input from input device 820. A user interface may include, among other possibilities, a web browser and/or a client application. Web browsers enable users, such as user 801, to display and interact with media and other information typically embedded on a web page or a website from DMA computer system 710. A client application may allow user 801 to interact with, for example, DMA computer system 710. For example, instructions may be stored by a cloud service, and the output of the execution of the instructions sent to the media output component 815.

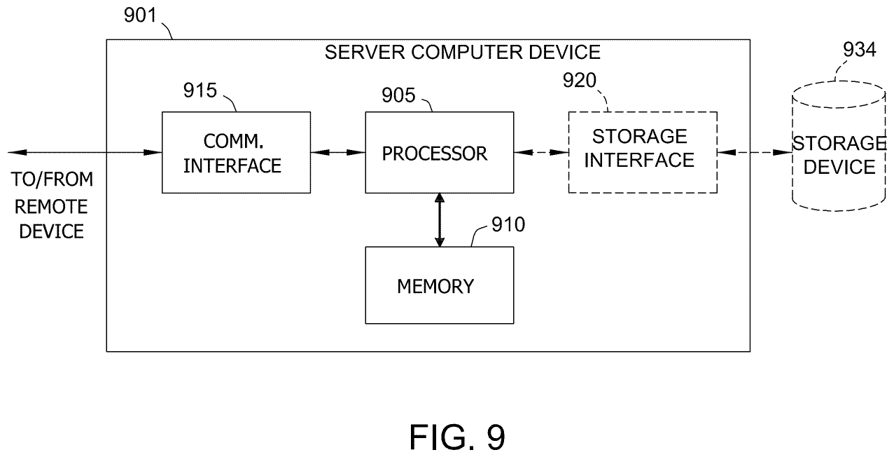

FIG. 9 depicts an exemplary configuration of server system, in accordance with one embodiment of the present disclosure. Server computer device 901 may include, but is not limited to, DMA computer system 710, database server 715, and external data resources 725 (all shown in FIG. 7). In some embodiments, server computer device 901 is a part of a cloud client server deployment. Server computer device 901 may also include a processor 905 for executing instructions. Instructions may be stored in a memory area 910. Processor 905 may include one or more processing units (e.g., in a multi-core configuration).

Processor 905 may be operatively coupled to a communication interface 915 such that server computer device 901 is capable of communicating with a remote device such as another server computer device 901, DMA computer system 710, and user computer device 705 (shown in FIG. 7) (for example, using wireless communication or data transmission over one or more radio links or digital communication channels). For example, communication interface 915 may receive requests from user computer devices 705 via the Internet, as illustrated in FIG. 7.

Processor 905 may also be operatively coupled to a storage device 934. Storage device 934 may be any computer-operated hardware suitable for storing and/or retrieving data, such as, but not limited to, data associated with database 720 (shown in FIG. 7). In some embodiments, storage device 934 may be integrated in server computer device 901. For example, server computer device 901 may include one or more hard disk drives as storage device 934.

In other embodiments, storage device 934 may be external to server computer device 901 and may be accessed by a plurality of server computer devices 901. For example, storage device 934 may include a storage area network (SAN), a network attached storage (NAS) system, and/or multiple storage units such as hard disks and/or solid-state disks in a redundant array of inexpensive disks (RAID) configuration.

In some embodiments, processor 905 may be operatively coupled to storage device 934 via a storage interface 920. Storage interface 920 may be any component capable of providing processor 905 with access to storage device 934. Storage interface 920 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 905 with access to storage device 934.

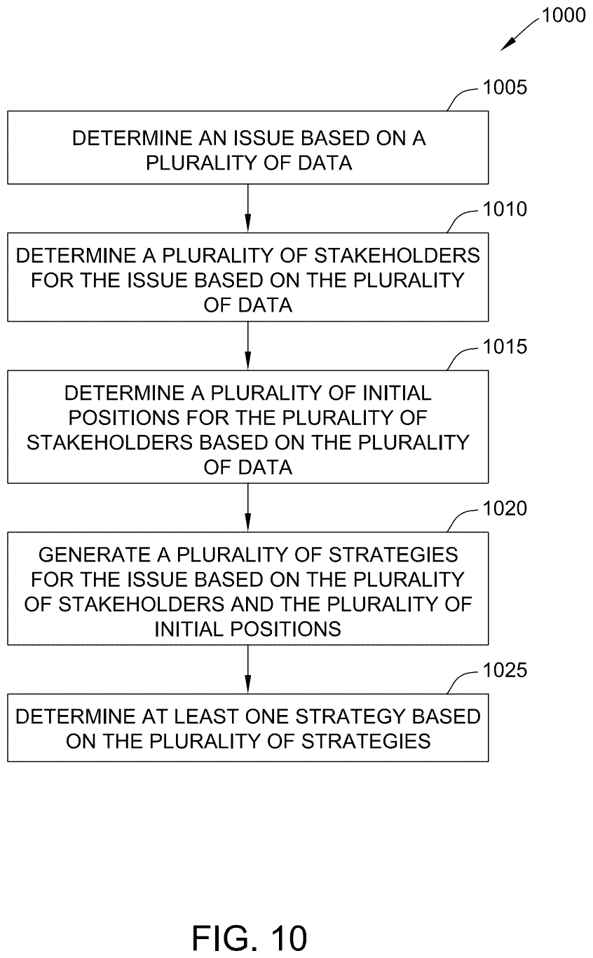

Processor 905 may execute computer-executable instructions for implementing aspects of the disclosure. In some embodiments, the processor 905 may be transformed into a special purpose microprocessor by executing computer-executable instructions or by otherwise being programmed. For example, the processor 905 may be programmed with the instructions. For example, the processor 905 may be programmed with the instructions, such as those shown in FIG. 10.

FIG. 10 illustrates a flow chart of a process 1000 for determining optimal paths for multi-party situations through high-level simulation as shown in FIGS. 1 to 4 using the decision-making analysis system 700 shown in FIG. 7. In the exemplary embodiment, process 1000 is performed by DMA computer system 710 (shown in FIG. 7).

In the exemplary embodiment, DMA computer system 710 determines 1005 an issue based on a plurality of data. In some embodiments, an issue is a situation or a negotiation that the user desires to be resolved. In the exemplary embodiment, the DMA computer system 710 determines 1010 the plurality of stakeholders associated with the issue based on the plurality of data. In the exemplary embodiment, an issue has a plurality of stakeholders, individuals and/or entities that are involved. The user also sets a goal, which may be a specific condition, or it may be where the stakeholders are within a specific range of the goal. For example, the goal may be to have the stakeholders be at 90% in favor of selling the company and the goal range may be where it would be acceptable for stakeholders to be anywhere between 70% and 100%. This range may be known as the green zone. In some embodiments, the stakeholders are broken up into categories, such as client, proxy, target, and veto. Client stakeholders may represent the user or group that the user represents. Proxy stakeholders are stakeholders that the client stakeholder may apply leverage to act strategically on the client stakeholders' behalf. Target stakeholders are the stakeholders that the user or client stakeholder wants to move towards the goal. Veto stakeholders are ones that have to be in the green zone to achieve the goal. Even if all of the other stakeholders are in the green zone, if a veto stakeholder is not in that zone, the scenario fails. The goal may also be to have a specific number or percentage of the stakeholders be within the goal range. Some stakeholders may be integral to the issue, while others are peripheral. Many stakeholders may be analyzed because a stakeholder that appears to be peripheral might actually affect the issue if influenced in a specific manner. Each stakeholder has a position. The stakeholder may be positively or negatively inclined in regard to the issue. This may be represented as a percentage. For example if the issue is a negotiation for a sale, the stakeholder may be 25% inclined to allow the sale to proceed, wherein the higher the percentage is, the more favorably inclined the stakeholder is. In some embodiments, the issue is defined by the user. In other embodiments, the issue is determined by the DMA computer system 710 based on the plurality of data. In the exemplary embodiment, the DMA computer system 710 determines 1015 a plurality of initial positions for the plurality of stakeholders based on the plurality of data.

In the exemplary embodiment, the DMA computer system 710 generates 1020 a plurality of strategies for the issue based on the plurality of stakeholders and the plurality of initial positions. Each strategy of the plurality of strategies includes one or more actions. Each strategy also includes a plurality of positions associated with each stakeholder of the plurality of stakeholder. During a round, one or more of the positions of the plurality of positions changes based on at least one of the one or more tactics or actions. The strategies and tactics test what occurs when different actions are taken or occur. For example, what happens if stakeholder A is approached in a hard manner, what happens if stakeholder A is approached in a friendly manner, and what happens if stakeholder B is approached before stakeholder A? For each stakeholder, the DMA computer system 710 stores a plurality of information about how that stakeholder reacts. What is important to that stakeholder and who does that stakeholder admire, get along with, dislike, or oppose. The DMA computer system 710 accesses this information to generate strategies based on how the stakeholders would react when certain actions are taken. The DMA computer system 710 also determines the desired outcome.

In the exemplary embodiment, the DMA computer system 710 determines 1025 at least one strategy based on the plurality of strategies. A strategy is a series of steps or tactics to achieve a goal or reach a particular situation.

In some embodiments, the DMA computer system 710 receives a plurality of data from a plurality of sources. These sources may be external data resources 725 (shown in FIG. 7), including, but not limited to, publically available databases, governmental databases, social media information and messages, subject matter expert reports and papers, and news articles. In some further embodiments, the DMA computer system 710 converts the plurality of data into a common format prior to using it.

In some embodiments, the DMA computer system 710 receives one or more user preferences 110 (shown in FIG. 1) for the issue from the user. The DMA computer system 710 ranks the plurality of strategies based on the one or more user preferences. The DMA computer system 710 uses the ranked plurality of strategies to determine the at least one strategy. For example, a user preference may be that the user wants the negotiation to be quick; therefore, the plurality of strategies is ranked on how quickly they reach the desired outcome.

In some embodiments, the DMA computer system 710 analyzes the plurality of strategies to determine one or more adjustments to at least one of the plurality of stakeholders and the plurality of initial positions. The DMA computer system 710 generates a second plurality of strategies for the issue based on the updated plurality of stakeholders and the updated plurality of initial positions. In some further embodiments, the DMA computer system 710 applies one or more of the plurality of actions to the positions of the stakeholders to determine one of more results includes updated positions of the stakeholders. The one or more results are used as inputs for a subsequent round.

In still further embodiments, the DMA computer system 710 determines a plurality of leverages based on the plurality of rounds. Leverages are tactics and influences that could potentially change the position of one or more stakeholders, but may be misperceived by one or more of the stakeholders, where an individual's public image portrays one thing and then actually changes position based on another. The DMA computer system 710 ranks the plurality of leverages based on one or more criteria. The one or more criteria may include, but is not limited to, a magnitude of the leverage, a consistency of the leverage, and an effective power of a stakeholder associated with the leverage. In these embodiments, the DMA computer system 710 filters the ranked plurality of leverages using both rule based and machine learning techniques. For example, the DMA computer system 710 may filter out all but a top ranked number of leverages. The DMA computer system 710 determines a plurality of tactics associated with the remaining leverages. These tactics include plurality of actions or steps required to achieve the leverage, such as approaching and making offers to certain individuals in a certain order.

The DMA computer system 710 ranks the plurality of tactics and determines the strategy based on the ranked plurality of tactics. The DMA computer system 710 ranks the plurality of tactics based on a total number of stakeholders involved, a number of stakeholders moved, and a number of drivers required.

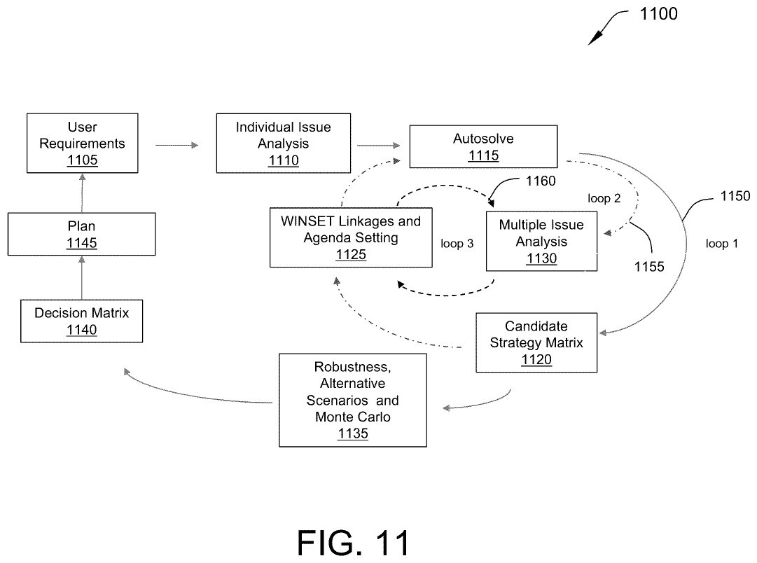

FIG. 11 illustrates a data flow diagram for a process 1100 for determining optimal paths for multi-party situations with multiple issues in accordance with one embodiment of the disclosure. In the exemplary embodiments, process 1100 is performed by the DMA computer system 710, shown in FIG. 7. In situations with multiple issues, the DMA computer device 710 compares the results of the different scenarios on the multiple issues to determine whether or not there is any overlap and if the resolution of one of the issues may affect the resolution of one of the other issues within a multi-issue negotiation.

In the exemplary embodiment, the DMA computer device 710 receives the user requirements 1105. The user requirements 1105 include the user identifying a goal. In some embodiments, the goal is a position on the issue continuum, such as getting the stakeholders to be 90% in favor of selling the company. The goal may also include a goal range, where it would be acceptable for stakeholders to be anywhere between 70% and 100%. The user requirements 1105 may also include collecting user preferences 110 and data 115, as shown in FIG. 1.

The DMA computer device 710 performs individual issue analysis 1110. This includes determining who the stakeholders are, what are the issues, what is the anticipated basecase outcomes of the negotiation currently, and other individual issue data. Then the DMA computer device 710 autosolves 1115 the issue. This may include many of the steps in process 100 to determine the strategy levers, stakeholder position changes, importance changes, and tactical leverage targeting-creating a portfolio of ‘Who does what to whom, when and how?’ to achieve user's desired goal outcomes. The results of the autosolving 1115 on the issue may resemble the plurality of strategies and tactics illustrated in graphical view 200, shown in FIG. 2.

The DMA computer device 710 then generates the candidate strategy matrix 1120 for the issue. In some embodiments, the candidate strategy matrix 1120 resembles the matrix 300, shown in FIG. 3. The candidate strategy matrix 1120 identifies potential strategy lever actions, tactics, and strategies that achieve the goal. The candidate strategy matrix may also include the likelihood and confidence levels for these actions, tactics, and strategies, subject to constraints. In some embodiments, the criteria are weighted by requirements, such as, but not limited to, suitability, feasibility, acceptance, distinguishability, and completeness. This candidate strategy matrix 1120 may be for single dimensions, if there is only one issue, or for multiple dimensions in the case of multiple issues, where each issue is associated with a dimension of a negotiation. For example, a multi-party contract negotiation might involve multiple negotiation issues, such as price, scope of services, delivery time and payment methods.

If there is only one issue, then the DMA computer device 710 proceeds to determining the robustness, alternative scenarios, and Monte Carlo analysis 1135. However, if there is more than one issue, the DMA computer device 710 analyzes the winset linkages and agenda setting 1125. Setting the agenda 1125 assists the user in determining how to negotiate multiple issues, such as whether or not to negotiate everything simultaneously, consecutively, together, and/or separately.

In the exemplary embodiment, the DMA computer device 710 includes a winset module. The winset module is configured to provide ways to take advantage of multiple negotiation issues concurrently. If more than two stakeholders are shared (shared stakeholders) between multiple issues (n>=2) at same time, there's opportunity to make trades across negotiation issues.

For example, if stakeholders A, B and C are involved in both issue 1 and issue 2 currently, given the continuum of these two issues, these three stakeholders can be mapped into a Cartesian two-dimensional issue spaces based on their position in each issue. Assuming that Stakeholders A and B are willing trade-off their advantages between issue 1 and 2, they might find a better solution for both issues jointly, than to solve those issue independently and separately.

In order to do so, spatial bargaining approaches are used to find where a trade-off is beneficial, called a ‘winset’ which is the set of points that is acceptable by all stakeholders, to solve those multiple issues. In the software embodiment, given set of stakeholders (two or more than two stakeholders) in the shared stakeholders, these shared stakeholders can trade off their advantages in one issue with other issues to achieve beneficial results. As used herein, the advantage is characterized by how close the current stakeholder's position compared to the median position, which is the forecasted current negotiation result from an individual issue. In some instances of the system, the closeness is calculated by vector minimization methods across non-convex sets to incorporate the misperceptions of Stakeholder risk profiles. Winsets provide optimal negotiation tactics and proposals that either create Pareto optimal outcomes or maximize each party's utility when stakeholders bargain across n multiple issues.

This process can be applied sequentially among multiple stakeholders and also across more than two issues. For example, Stakeholder A and B find a winset on issues 1 and 2 as their first negotiation proposal, then Stakeholders A and B given their new agreed issue positions on issues 1 and 2 with Stakeholder C on the same or different issue. Other combinations of stakeholders, issues and the ordering of proposals are also considered by the DMA computer device 710. The winset comparison is performed for each pair of issues, e.g. issue 1 vs. issue 2, issue 2 vs. issue 3, and issue 1 vs. issue 3. In some instances of the system, higher order, n issues dimensions are also explored in non-Euclidean space.

After the Winset module is executed, the DMA computer device 710 generates a matrix of n−1 by n issue tradeoffs, showing if a beneficial trade off or winset exists for a particular client Stakeholder on any pairwise set of issues. This Winset ‘linkage matrix’ helps determine what is the right order of negotiating which issues and in what sequence. This is often called ‘agenda setting’ in communications theory. The system then prioritizes and sequences the agenda, the order of issues, and the order of negotiation tactics and strategies, to achieve optimal outcomes for a particular set of client stakeholders, subject to the existence of beneficial negotiation trade-offs across multiple issues, user's particular risk appetite, goals and constraints as already determined through the Search Strategy Space 130 and Strategy Ranking modules 140.

FIG. 6 shows an example of how the ordering of four issues in a multi-party negotiation could be performed. For example, all four issues may be discussed separately and sequentially, one after another, based upon the above winset linkage matrix results and other criteria. Alternatively, all four issues may be discussed concurrently, but kept separate during discussions. Additionally, all four issues may be discussed in a particular order or agenda, for example linking issues 1 and 4 together first, then discussing the remaining issues subsequently to achieve desired outcomes subject to user inputted criteria previously discussed.

The process of considering all issues involved in a multiparty, single or multi-issue negotiation case can be cumbersome and error prone. The proper design of critical positions for each issue can take a long time and the quality of analysis depends on this process, too. In order to facilitate this process, the DMA computer device 710 may provide several built-in templates for most frequently used types of multi-party, single, and multi-issue negotiations, including regulation, lobbying, M&A, joint ventures, contract negotiations, litigation settlement, political risk, and economic policy, etc. In these templates, users will have some issues already created with issue continuum that are usually critical in that kind of negotiations. Then, if needed, users can add additional issues or further customize positions upon it. Users can also merge multiple templates to create unique, customized multi-issue negotiation analyses.

The templates also include lists of stakeholder types that are usually involved in such types of multi-party negotiations. For example, these include acquirers, buyers, sellers, management, regulators, media, government, civil society, regulators, shareholders, board members, etc. This significantly facilitates the user data entry procedure to guide users to adding important stakeholders who are usually associated with a particular type of multi-party negotiation.

In the exemplary embodiments for multiple issues, the DMA computer device 710 performs three loops. Loop 1 1150 includes autosolving 1115 for all of the individual issues. Then Loop 2 1155 compares the autosolved issues in pairs. The winset linkages 1125 performs pairwise and higher n order comparisons to allow analysis on complex multiple, contingent decision spaces. The winset module identifies which issues to link, when, how, and by whom to achieve goals, constraints, and requirements. For example, issues 1 and 4 may be linked as being resilient against adversary action. Loop 3 1160 performs multiple issue analysis 1130 by analyzing all of the pairs to compare all of the pair comparisons to determine ideal paths. The multiple issue analysis 1130 may compare the single issues sequential and parallel strategy outcomes versus multiple, linked, or contingent decision spaces with alternative futures branches and sequels.

The robustness, alternative scenarios, and Monte Carlo simulation 1135 analyzes scenarios that subject matter experts are currently considering as potential branches. The DMA computer device 710 tests facts and assumptions via sensitivity analysis. The DMA computer device 710 analyzes stakeholder input positions endogenous, influence, and importance, subject to random uniform exogeneous shocks via Monte Carlo simulation. The DMA computer device 710 compares the basecase results to the Monte Carlo shock results. Then the DMA computer device 710 identifies significantly different Monte Carlo outcomes and cluster/classify input triggers for alternative future branches to provide robust adaptive strategic planning.

A decision matrix 1140 is generated to analyze all of the potential courses of action from all of the relevant alternative futures to determine which ones satisfy user's goals, constraints, multi-objectives, and risk appetite. The DMA computer device 710 filters strategy applicability by branches and sequels.

Then the DMA computer device 710 generates one or more plans 1145 based on the issues analyzed. The plans may be ranked or ordered based on paths of actions, strategies, key performance indicators, and assessments of the viability of each plan.

In the exemplary embodiment, the DMA computer device 710 generates a text narrative report of the results of the analysis. In the exemplary embodiment, the report includes a strength, weakness, opportunity, and threat (SWOT) analysis of each negotiation simulation. In some embodiments, the report includes narrative analytics and an expert system to automatically generate summary text that interprets the results of each decision-making simulation in natural language. In some embodiments, the DMA computer device 710 uses the key performance indicators and criteria that measure how good each model simulation run is, with percentage goal attainment, likelihoods via Monte Carlo simulation methods, and finally confidence through law of large number simulation techniques. Given the various key performance metrics, the system automatically generates a text report for human consumption.

In the exemplary embodiment, the DMA computer device 710 utilizes key performance metrics for the SWOT analysis, and then takes each simulation result, and categorizes the Stakeholders' dynamics, positions, expected utilities, network of relations, etc. into a narrative text. The DMA computer device 710 may also create scores for each SWOT category that allow users to quickly compare SWOT scores across multiple negotiation simulations. Individual simulations are compared and contrasted to write meta-level reports that summarize all analyses into Headlines for each page, as well as more detailed subtexts to describe both single issue and multi-issue analysis and the resulting negotiation plan.

In an exemplary embodiment, a user selects an issue and associated issue continuum. The issue may be based on a template or pre-performed analysis. The issue may also be a new issue that the user has developed. The issue includes the stakeholders, their initial positions on the continuum, their influence, group influence, importance, and role in the issue. The user also sets a goal, which may be a specific condition, or it may be where the stakeholders are within a specific range of the goal. For example, the goal may be to have the stakeholders be at 90% in favor of selling the company and the goal range may be where it would be acceptable for stakeholders to be anywhere between 70% and 100%. This range may be known as the green zone.

In some embodiments, the stakeholders are broken up into categories or roles, such as client, proxy, target, and veto. Client stakeholders may represent the user or group that the user represents. Proxy stakeholders are stakeholders that can act strategically on the client stakeholders' behalf. Target stakeholders are the stakeholders that the user or client stakeholder wants to move towards the goal. Veto stakeholders are ones that have to be in the green zone to achieve the goal. Even if all of the other stakeholders are in the green zone, if a veto stakeholder is not in that zone, the scenario fails. The goal may also be to have a specific number or percentage of the target stakeholders be within the goal range to be successful or other additional conditions, such as having success within a certain number of rounds of negotiation.

The DMA computer device 710 determines strategies that move the key target stakeholders closest to the goal position. The DMA computer device 710 uses the systems and methods described herein to search for potential tactics and strategies for client stakeholders to move the target stakeholders towards a position within the goal range. The DMA computer device 710 will tailor the strategies found based on the user preferences, such as by finding and organizing the strategies based on these preferences. For example, the user may range optimal and unanimous strategies higher than others like consensus, fastest, safest, and efficient. These strategies will be based on potential leverages client and proxy stakeholders on the target stakeholders identified by the DMA computer device 710 in Strategy Search Space 130 and then rank those strategies based on user preference in Strategy Ranking 140.

Using the basecase as the starting point, the DMA computer device 710 will analyze potential tactics and strategies to determine whether or not the goal is achieved within a certain number of rounds of negotiation and provide a level of confidence or likelihood associated with each of the scenarios. In some embodiments, the DMA computer device 710 may determine a percentage of goal achieved, a likelihood that the goal will be achieved at that point, and a confidence level associated with the likelihood. For example, a likelihood may be low (e.g. 5%) with a confidence level of high (e.g. 90%). This means that the system is confident that the likelihood of the goal being achieved with this scenario is very low. As described herein, the user may run multiple scenarios on multiple issues to determine if those issues may affect each other. The user may adjust one or more settings, assumptions, or other data to try different scenarios to attempt to achieve other results.

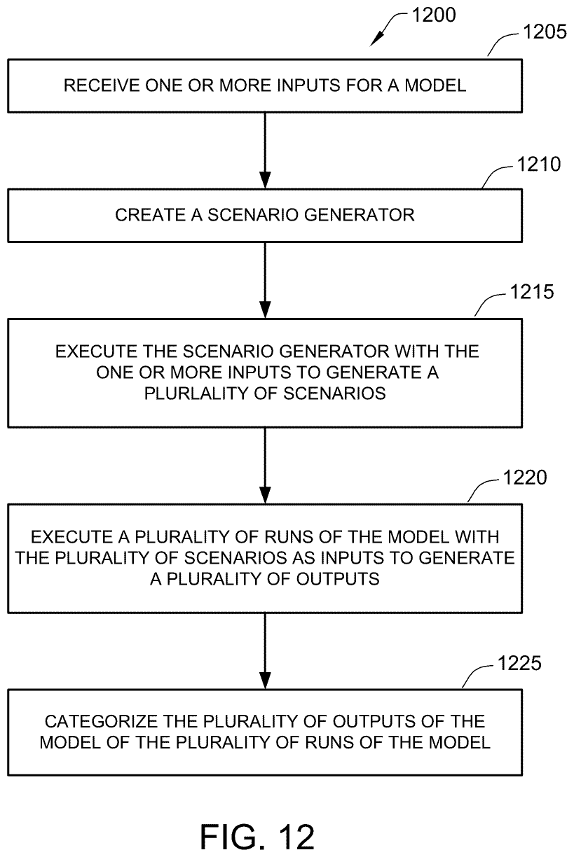

FIG. 12 illustrates a flowchart of process 1200 for scanning for advanced horizon scanning and deep searching system, in accordance with at least one embodiment. In the exemplary embodiment, process 1200 is performed by the DMA computer device 710 (shown in FIG. 7). In some embodiments, process 1200 is a part of defining scenarios 120 (as shown in FIG. 1). In some further embodiments, process 1200 integrates one or more parts of analyzing data 125 (as shown in FIG. 1).

In the exemplary embodiment, the advanced horizon scanning and deep horizon scan searching system described herein is used to help to design experiments to determine potential alternative scenarios that may be used with this system to achieve a goal. The advanced horizon scanning and deep searching system uses smart statistical sampling of input parameter space sensitivities to figure out how outputs depend on different inputs.

In the exemplary embodiment, the DMA computer device 710 receives 1205 one or more inputs for an issue. In some embodiments, the issue relates to one or more models. In other embodiments, the one or more inputs are specific to the issue. For any given data input, the DMA computer device 710 uses a data generating process (DGP) to generate an output model. In some embodiments, the DGP includes one or more parts of process 1000 (shown in FIG. 1). The DMA computer device 710 saves the one or more inputs as data inputs. The DMA computer device 710 runs the data inputs through the DGP model to generate baseline results. The DMA computer device 710 saves the dependent variables that were output from the run of the DGP model with the one or more inputs as the baseline results.

In the exemplary embodiment, the DMA computer device 710 creates 1210 a scenario generator. In the exemplary embodiment, the scenario generator is created 1210 to handle ‘unknown unknows” or scenarios and risks that are not identified by humans. In the exemplary embodiment, the dependent variable (DV) of interest is kept fixed with the original data values. Then, in one example, all other independent variables (IV) are varied randomly and uniformly across their entire range, such that IVs∈[Xₘᵢₙ, Xₘₐₓ]. In one embodiment, the DV is a stakeholder position, and the IVs are stakeholders' influence, importance, and group influence, although any data metrics are also possible.

In the exemplary embodiment, the DMA computer device 710 executes 1215 the scenario generator with the one or more inputs to generate a plurality of scenarios. As a part of the horizon scanning process, the DMA computer device 710 create hᵢ new input scenarios, where i could be thousands or greater. The new scenarios are created via the scenario generator.

In the exemplary embodiment, the DMA computer device 710 executes 1220 a plurality of runs of the model with the plurality of scenarios as inputs to generate a plurality of outputs. The DMA computer device 710 run the scenarios through a DGP model i times. The DMA computer system 710 saves each of the hᵢ runs, with associated DV output values and IV input values.

In the exemplary embodiment, the DMA computer device 710 categorizes the plurality of outputs of the model of the plurality of runs of the model. More specifically, the DMA computer device 710 categorizes hᵢ horizon scan DV output runs into different categories according to deviations from baseline DV output or other desired target KPIs. As discussed herein, the runs in each category are stored in a quantized bin for that category. The bin is a virtual representation to collate runs that are in the same category. The DMA computer device 710 then determines which new h scenario runs DV output are in similar ranges to baseline run DV output and which new h scenario runs DV outputs are very different ranges to baseline run DV output.

In some embodiments, the DMA computer device 710 then may make comparison based upon categorized bin unit interval ranges. For example, the system may have a goal percentage range of 1-100 for DV, percentage likelihood and confidence ranges, or any other target metric. In one example, the system has 11 bins, which are based upon decile percentage differences from the baseline outcome; 0-10 bin 1, 11-20 bin 2, 21-30 bin 3 . . . 91-100 bin 11. In other embodiments, different percentages, ranges, and/or DV may be used with different categorized bins on different user selected KPIs. For example, comparisons can also be on continuous output DV ranges, such as the number of standard deviations from the baseline DV result). In another example, the DV could be straight goal completion percentage.

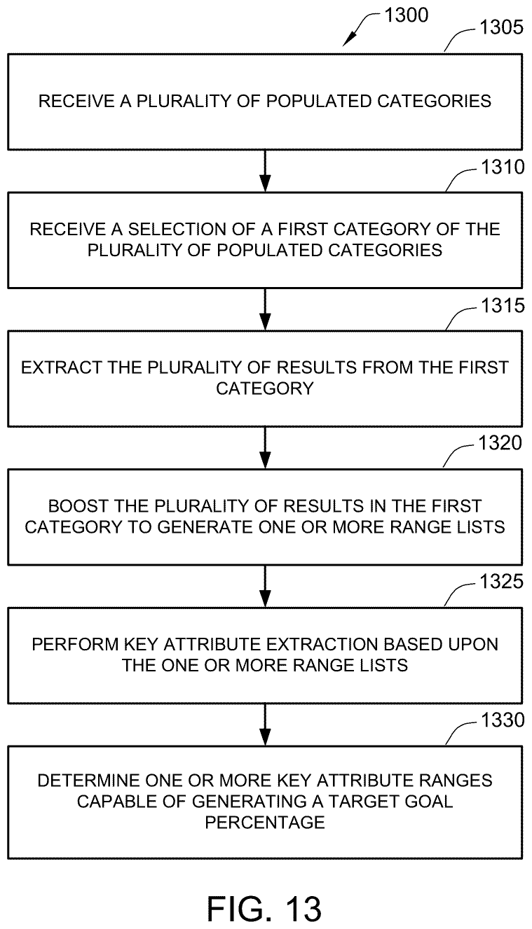

FIG. 13 illustrates a flowchart of process 1300 for deep searching for the advanced horizon scanning and deep searching system, in accordance with at least one embodiment. In the exemplary embodiment, process 1300 is performed by the DMA computer device 710 (shown in FIG. 7). In some embodiments, process 1300 is a part of defining scenarios 120 (as shown in FIG. 1). In some further embodiments, process 1300 integrates one or more parts of analyzing data 125 (as shown in FIG. 1).

In the exemplary embodiment, the DMA computer device 710 receives 1305 a plurality of populated categories. In the exemplary embodiment, the populated categories are based upon process 1200, described above. The populated categories each include one or more runs of generated scenarios that achieved different goal percentages, where the runs have been categorized by the output goal percentage.

In the exemplary embodiment, the DMA computer device 710 receives 1310 a selection of a first category of the plurality of categories. In some embodiments, the first category is selected by the user. In other embodiments, the DMA computer device 710 selects the first category based on historical performance and/or user preferences. In one example, the DMA computer device 710 selects the category that is for results that are three standard deviations away from the basecase or in a specific quantized bin number. In other embodiments, the DMA computer device 710 selects the category that is for results that have 100% goal completion or other categorized KPIs. In the exemplary embodiment, the DMA computer device 710 extracts 1315 the plurality of results from the first category.

In the exemplary embodiment, the DMA computer device 710 boosts 1320 the plurality of results in the first category to generate one or more range lists. The output is a range list for all stakeholders' attributes. The deep search focuses on finding the hᵢ input scenarios that produce the significantly different bin results from the baseline DV output results.

In some embodiments, based on initial result from hᵢ, the DMA computer device 710 runs nonparametic statistical tests to test distributions from different samples. In one example, a Kolmogorov-Smirnov test, Cramer-Von Mises test and Anderson-Darling tests are performed on each IVs that generate results in the first category and the overall results HO (the basecase). These statistical tests compare the distribution of hᵢ first category different IV changes to a random normal distribution to see which changes are statistically significantly. It is non-parametric and agnostic to what the distribution actually is. In other embodiments, the DMA computer device 710 uses machine learning clustering techniques, such as density, distribution, centroid and hierarchical methods, including K Means, DBSCAN, Gaussian Mixture Models and Hierarchical Agglomerative Clustering among others.

The DMA computer device 710 sorts the nonparametric test results by p-value in ascending order and selects statistically significant input IVs based upon p-values. This identifies the IV changes that more statistically significant to lead to the quantized target bin results vs the baseline results. For each identified IV, the DMA computer device 710 finds the new range that its distributions have the biggest area difference between the two distributions.

Then the DMA computer device 710 executes the DGP model again with all of the identified IVs shocked uniformly with their new ranges. Furthermore, all other IVs are shocked uniformly for their original ranges. This provides the result h1. The DMA computer device 710 repeats Step 1320 until all the result are fall into the first category or all IV p-values are greater than 0.05.

In the exemplary embodiment, the DMA computer device 710 performs 1325 key attribute extraction based upon the one or more range lists. The key attribute exaction refinement after deep search process includes refining the list to contain the fewest IVs changes sufficient to generate the categorized target result.

For the identified IVs that are sensitive to producing the target outcomes, the DMA computer device 710 sorts their ranges by min-distance-to-baseline values in descending order. The DMA computer device 710 shocks the first IV ranges while all other IV stay at their original value. The DMA computer device 710 runs a test run and checks if results pass a sample threshold. If not, the DMA computer device 710 adds the second IV from the list and repeats the process until the results passes the threshold.

The DMA computer device 710 determines 1330 and outputs one or more key attribute ranges capable of generating the quantized bin target goal percentage or other desired evaluation metrics.

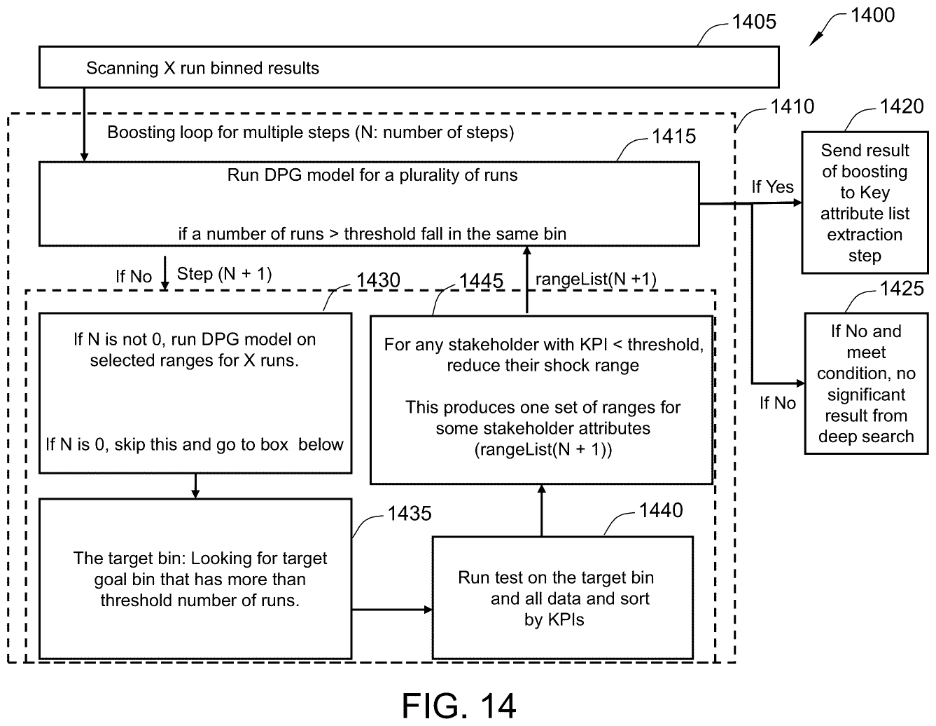

FIG. 14 illustrates an exemplary boosting process 1400 for deep searching in accordance with at least one embodiment of the disclosure. In the exemplary embodiment, process 1400 is performed by the DMA computer device 710 (shown in FIG. 7). In some embodiments, process 1400 is a part of defining scenarios 120 (as shown in FIG. 1). In some further embodiments, process 1400 integrates one or more parts of analyzing data 125 (as shown in FIG. 1). In the exemplary embodiment, process 1400 is a part of process 1300 (shown in FIG. 13).

In the exemplary embodiment, the DMA computer device 710 receives 1405 the categorized results from the scanning done in process 1200 (shown in FIG. 12). Then the DMA computer device 710 begins a boosted loop 1410 for multiple (N) steps. In some embodiments, N may be any number of steps based upon the desired outcome and the searching being performed.

In the exemplary embodiment, the DMA computer device 710 runs 1415 a test run. The test run is based on rangeList(N), which was retrieved in step 1405. The test run keeps all other attributes not in rangeList(N) at basecase values. In the exemplary embodiment, the test run is a run of the DGP model. In some embodiments, the DMA computer device 710 runs a plurality of runs of the DGP model to confirm that a percentage or number (e.g., >40%) of those runs fall within the desired quantized category/bin for any desired KPI.

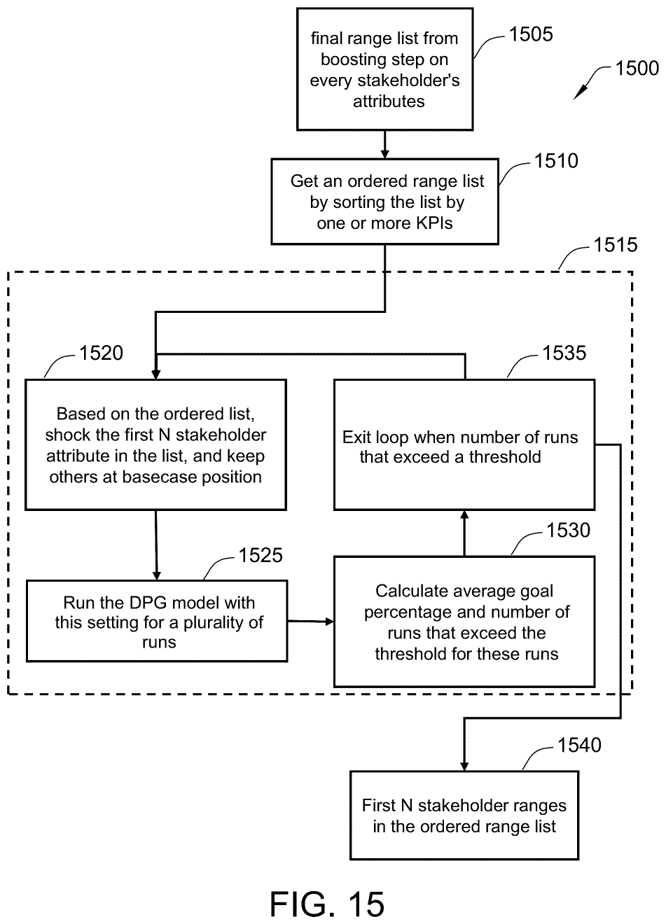

If the threshold is exceeded, the DMA computer device 710 sends 1420 the results of the boosting to the Key attribute list extraction step, as shown in FIG. 15.

If the threshold is not exceeded, then the DMA computer device 710 checks 1425 checklist of loop termination conditions to determine whether to terminate the boosted loop 1410 or continue for another pass of the loop 1410. Examples of loop termination conditions include, but are not limited to, one or more KPIs (key performance indicators) exceed or meet desired thresholds, the test runs exceed the threshold of runs falling within the desired category/bin, all pValues greater than or less than a desired value (i.e., 0.05), and/or the number of loops exceeds a loop threshold.

If the DMA computer device 710 determines to perform a loop 1410, the DMA computer device 710 proceeds to Step 1430. If N is not zero, then the DMA computer device 710 runs 1430 the DGP model on the selected ranges for X number of run. If N is zero, then Step 1430 is skipped. For Step 1430 the selected ranges mean uniformly shocking stakeholder attributes on ranges in the rangeList(N), while uniformly shocking other attributes that are not included in rangeList1. These are shocked from 0 to 1.

In the exemplary embodiment, the DMA computer device 710 scans 1435 for the target goal category/bin that has more than a minimum threshold number of runs, e.g., 50 or 5000 runs. If the number of runs in the target goal category/bin are insufficient to exceed the threshold, the DMA computer device 710 merges with adjacent and nearby goal category/bins until the minimum threshold number of runs is exceeded. When merging higher goal percentage category/bins have priority. For example, if the target goal percentage was 80%, then the 90% category/bin is merged and checked first, then 100%, before the 70% category/bin.

In the exemplary embodiment, the DMA computer device 710 runs 1440 tests on the target category/bin and all data for X runs. Then the DMA computer device sorts by desired KPIs. In one embodiment, the KPI is pValues and the DMA computer device 710 sorts the pValues from small to large.

In the exemplary embodiment, for any stakeholder with a KPI <the desired threshold, the DMA computer device 710 reduces 1445 their shock range by the largest range that has the greatest area different between the best cluster distribution and overall. This produces one set of ranges for some stakeholder attributes. This set of ranges could be called rangeList(N+1). This rangeList(N+1) is passed to Step 1415 for another range test run using rangeList(N+1). In some embodiments, the DMA computer device 710 is looking for KPIs that are greater than or meet the desired threshold to proceed to Step 1445.

In some embodiments, the DMA computer device 710 includes an early termination rule. If the result failed to reach at least a minimum (i.e., 50 runs, 20% of X runs) by running this inside loop 1410 five times (steps), the DMA computer device 710 starts over the loop 1410 from the beginning. If during the second time the loop 1410 doesn't generate good results (for example, doesn't reach at least 50 runs 20% of # of runs), then the DMA computer device 710 terminates the process 1400 and determines that there are no significant results for deep search.

After exiting the loop in Step 1415, rangeList(N+1) is the result. rangeList(N+1) contains the combinations of all shrank ranges for attributes in each loop steps. The length of rangeList can be anything between 0 and (length of stakeholders*number of attributes). The final range list from boosting step is rangeList plus any stakeholder attribute not in rangeList, which will be noted as [0, 1]. Therefore, the final range list from boosting step will have the same length with (number of stakeholders*number of attributes). E.g., if there are 33 stakeholders and two attributes are shocked, which are influence and importance. The final range list from boosting step may have a length of 33*2=66.

FIG. 15 illustrates an example of the key attribute extraction process 1500 for deep searching in accordance with at least one embodiment of the disclosure. In the exemplary embodiment, process 1500 is performed by the DMA computer device 710 (shown in FIG. 7). In some embodiments, process 1500 is a part of defining scenarios 120 (as shown in FIG. 1). In some further embodiments, process 1500 integrates one or more parts of analyzing data 125 (as shown in FIG. 1). In the exemplary embodiment, process 1500 is a part of process 1300 (shown in FIG. 13). Furthermore, process 1500 occurs after process 1400 (shown in FIG. 14), such as from Step 1440 (shown in FIG. 14).

In the exemplary embodiment, the DMA computer device 710 receives 1505 the final range list from the boosting step on every stakeholder's attributes. The DMA computer device 710 gets 1510 an ordered range list by sorting the list by one or more KPIs, such as, but not limited to, minimum distance to base position. In some embodiments, the ordered range list is sorted in descending order, from large to small. This leads to key attribute extraction loop 1515.

Based on the ordered list, the DMA computer device 710 shocks 1520 the first N stakeholder attributes on the list, while keeping the other attributes at the basecase position. Then the DMA computer device 710 runs 1525 the DGP model with this setting for a plurality of runs (e.g., 2000). The DMA computer device 710 calculates 1530 the goals and the number of runs that reach that goal. For example, the goal may be average goal percentage. In another example the goal is exceeding a KPI threshold. The DMA computer device 710 determines 1535 if the number of runs that reach the goal also exceeds another KPI threshold. If the number of runs exceeds the KPI threshold, the DMA computer device 710 exits the loop 1515 and submits 1540 the first N stakeholder ranges in the ordered range list. If the number of runs does not exceed the threshold, the DMA computer device 710 proceeds to Step 1520 and continues the loop 1515.

In the exemplary embodiment, the goal for key attribute list extraction is to find the smallest subset of full range list for that stakeholder attributes that can generate sufficient result that meet target goal percentage. The system then outputs all significant stakeholder attributes and generates a report on the specific scenario conditions to provide an early warning and advanced horizon scan on unknown scenarios that could significantly impact anticipated system outcomes.

At least one of the technical solutions to the technical problems provided by this system may include: (i) improved speed and accuracy for optimal path determination; (ii) identifying hidden agendas of stakeholders; (iii) determining paths based on user preferences; (iv) customizable path generation; and (v) analyzing paths for multiple issues.

The methods and systems described herein may be implemented using computer programming or engineering techniques including computer software, firmware, hardware, or any combination or subset thereof, wherein the technical effects may be achieved by performing at least one of the following steps: (a) receive one or more inputs for a model associated with an issue; (b) create a scenario generator; (c) execute the scenario generator with the one or more inputs to generate a plurality of scenarios; (d) execute a plurality of runs of the model with the plurality of scenarios as inputs to generate a plurality of outputs; and/or (e) categorize the plurality of outputs of the model of the plurality of the plurality of runs of the model.

### Machine Learning & Other Matters

The computer-implemented methods discussed herein may include additional, less, or alternate actions, including those discussed elsewhere herein. The methods may be implemented via one or more local or remote processors, transceivers, servers, and/or sensors, and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

In some embodiments, the design system is configured to implement machine learning, such that the neural network “learns” to analyze, organize, and/or process data without being explicitly programmed. Machine learning may be implemented through machine learning (ML) methods and algorithms. In an exemplary embodiment, a machine learning (ML) module is configured to implement ML methods and algorithms. In some embodiments, ML methods and algorithms are applied to data inputs and generate machine learning (ML) outputs. Data inputs may include but are not limited to: analog and digital signals (e.g. sound, light, motion, natural phenomena, etc.) Data inputs may further include: sensor data, image data, video data, and telematics data. ML outputs may include but are not limited to: digital signals (e.g. information data converted from natural phenomena). ML outputs may further include: speech recognition, image or video recognition, medical diagnoses, statistical or financial models, autonomous vehicle decision-making models, robotics behavior modeling, fraud detection analysis, user input recommendations and personalization, game AI, skill acquisition, targeted marketing, big data visualization, weather forecasting, and/or information extracted about a computer device, a user, a home, a vehicle, or a party of a transaction. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, convolutional neural networks, recurrent neural networks, generative adversarial networks, dimensionality reduction, particle swarm optimization, genetic algorithms and support vector machines. In various embodiments, the implemented ML methods and algorithms are directed toward at least one of a plurality of categorizations of machine learning, such as supervised learning, unsupervised learning, and reinforcement learning.

In one embodiment, ML methods and algorithms are directed toward supervised learning, which involves identifying patterns in existing data to make predictions about subsequently received data. Specifically, ML methods and algorithms directed toward supervised learning are “trained” through training data, which includes example inputs and associated example outputs. Based on the training data, the ML methods and algorithms may generate a predictive function which maps outputs to inputs and utilize the predictive function to generate ML outputs based on data inputs. The example inputs and example outputs of the training data may include any of the data inputs or ML outputs described above. For example, a ML module may receive training data comprising customer identification and geographic information and an associated customer category, generate a model which maps customer categories to customer identification and geographic information, and generate a ML output comprising a customer category for subsequently received data inputs including customer identification and geographic information.

In another embodiment, ML methods and algorithms are directed toward unsupervised learning, which involves finding meaningful relationships in unorganized data. Unlike supervised learning, unsupervised learning does not involve user-initiated training based on example inputs with associated outputs. Rather, in unsupervised learning, unlabeled data, which may be any combination of data inputs and/or ML outputs as described above, is organized according to an algorithm-determined relationship. In an exemplary embodiment, a ML module coupled to or in communication with the design system or integrated as a component of the design system receives unlabeled data comprising customer purchase information, customer mobile device information, and customer geolocation information, and the ML module employs an unsupervised learning method such as “clustering” to identify patterns and organize the unlabeled data into meaningful groups. The newly organized data may be used, for example, to extract further information about the circuit.

In yet another embodiment, ML methods and algorithms are directed toward reinforcement learning, which involves optimizing outputs based on feedback from a reward signal. Specifically ML methods and algorithms directed toward reinforcement learning may receive a user-defined reward signal definition, receive a data input, utilize a decision-making model to generate a ML output based on the data input, receive a reward signal based on the reward signal definition and the ML output, and alter the decision-making model so as to receive a stronger reward signal for subsequently generated ML outputs. The reward signal definition may be based on any of the data inputs or ML outputs described above. In an exemplary embodiment, a ML module implements reinforcement learning in a user recommendation application. The ML module may utilize a decision-making model to generate a ranked list of options based on user information received from the user and may further receive selection data based on a user selection of one of the ranked options such as in the Leverage Pool 510 or Winset Linkage Matrix 1125. A reward signal may be generated based on comparing the selection data to the ranking of the selected option. The ML module may update the decision-making model such that subsequently generated rankings more accurately predict optimal constraints.

In some embodiments, the ML module may determine that generating one or more scenarios and/or strategies are unnecessary in future iterations due to a lack of results. Accordingly, the ML module instructs the DMA computer system 710 (shown in FIG. 7) to not generate those scenarios and/or strategies in future rounds, thereby saving time and processing power. Furthermore, the ML module may recognize patterns and be able to apply those patterns when generating scenarios and/or strategies to improve the efficiency of that process and reduce processing resources. In some embodiments, ML modules may be executed on ML training computational units customized for ML training. For example, in some embodiments, tensor processing units (TPUs) may be used for ML training.

### ADDITIONAL CONSIDERATIONS

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. In some embodiments, graphics processing unit (GPU) based RDBMS may be used to boost DB performance. As used herein, a database may include any collection of data including hierarchical databases, relational databases, flat file databases, object-relational databases, object-oriented databases, and any other structured or unstructured collection of records or data that is stored in a computer system. The above examples are not intended to limit in any way the definition and/or meaning of the term database. Examples of RDBMS's include, but are not limited to, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In another embodiment, a computer program is provided, and the program is embodied on a computer-readable medium. In an example embodiment, the system is executed on a single computer system, without requiring a connection to a server computer. In a further example embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computer devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present embodiments may enhance the functionality and functioning of computers and/or computer systems.

As used herein, an element or step recited in the singular and preceded by the word “a” or “an” should be understood as not excluding plural elements or steps, unless such exclusion is explicitly recited. Furthermore, references to “example embodiment,” “exemplary embodiment,” or “one embodiment” of the present disclosure are not intended to be interpreted as excluding the existence of additional embodiments that also incorporate the recited features.

Furthermore, as used herein, the term “real-time” refers to at least one of the time of occurrence of the associated events, the time of measurement and collection of predetermined data, the time to process the data, and the time of a system response to the events and the environment. In the embodiments described herein, these activities and events occur substantially instantaneously as well as in memory streaming analytics.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A decision-making analysis computer device for advanced horizon scanning and deep searching, the computer device comprising at least one processor in communication with at least one memory, the at least one processor programmed to:
receive one or more inputs for a model associated with an issue;
create a scenario generator;
execute the scenario generator with the one or more inputs to generate a plurality of scenarios;
execute a plurality of runs of the model with the plurality of scenarios as inputs to generate a plurality of outputs; and
categorize the plurality of outputs of the model of the plurality of the plurality of runs of the model.

2. The computer device of claim 1, wherein the issue relates to one or more models.

3. The computer device of claim 1, wherein the model is generated via a data generating process (DGP).

4. The computer device of claim 3, wherein the at least one processor is further programmed to:
save one or more of the one or more inputs as data inputs; and
execute the data inputs through the DGP model to generate baseline results.

5. The computer device of claim 4, wherein the DGP model outputs one or more dependent variables, and wherein the at least one processor is further programmed to save the one or more dependent variables from the execution of the DGP model with the one or more inputs as baseline results.

6. The computer device of claim 5, wherein the at least one processor is further programmed to run the plurality of scenarios through the DPG model a plurality of times.

7. The computer device of claim 6, wherein the at least one processor is further programmed to save values for the dependent variables and the independent variables.

8. The computer device of claim 1, wherein the at least one processor is further programmed to receive a dependent variable of interest, wherein the dependent variable of interest is kept fixed with original values in the plurality of scenarios.

9. The computer device of claim 6, wherein the at least one processor is further programmed to vary independent variables randomly and uniformly across their entire range.

10. The computer device of claim 9, wherein the independent variables include at least one of stakeholders' influence, importance, and group influence.

11. The computer device of claim 8, wherein the dependent variable of interest is a stakeholder position.

12. A system for advanced horizon scanning and deep searching, the system comprising a computer device comprising at least one processor in communication with at least one memory, the at least one processor programmed to:
receive one or more inputs for a model associated with an issue;
create a scenario generator;
execute the scenario generator with the one or more inputs to generate a plurality of scenarios;
execute a plurality of runs of the model with the plurality of scenarios as inputs to generate a plurality of outputs; and
categorize the plurality of outputs of the model of the plurality of the plurality of runs of the model.

13. The system of claim 12, wherein the issue relates to one or more models.

14. The system of claim 12, wherein the model is generated via a data generating process (DGP).

15. The system of claim 14, wherein the at least one processor is further programmed to:
save one or more of the one or more inputs as data inputs; and
execute the data inputs through the DGP model to generate baseline results.

16. The system of claim 15, wherein the DGP model outputs one or more dependent variables, and wherein the at least one processor is further programmed to save the one or more dependent variables from the execution of the DGP model with the one or more inputs as baseline results.

17. The system of claim 16, wherein the at least one processor is further programmed to run the plurality of scenarios through the DPG model a plurality of times.

18. The system of claim 17, wherein the at least one processor is further programmed to save values for the dependent variables and the independent variables.

19. The system of claim 12, wherein the at least one processor is further programmed to receive a dependent variable of interest, wherein the dependent variable of interest is kept fixed with original values in the plurality of scenarios.

20. The system of claim 17, wherein the at least one processor is further programmed to vary independent variables randomly and uniformly across their entire range.

21. The system of claim 20, wherein the independent variables include at least one of stakeholders' influence, importance, and group influence.

22. The system of claim 19, wherein the dependent variable of interest is a stakeholder position.
